(19) United States
(12) Patent Application Publication
(10) Pub. No.: US 2019/0172119 A1
(43) Pub. Date: Jun. 6, 2019

(54) CENTRALIZED SYSTEM OF AGGREGATED DATA SOURCES, PERSONALIZED ADVERTISEMENT, MATCHING LOGIC, FEATURES, AND METHODS OF USE

(71) Applicant: Mack Craft, Denver, CO (US)

(72) Inventor: Mack Craft, Denver, CO (US)

(21) Appl. No.: 16/213,959

(22) Filed: Dec. 7, 2018

Related U.S. Application Data
(63) Continuation-in-part of application No. 15/138,194, filed on Apr. 25, 2016.
Application No. 15/138,194 is a continuation-in-part of application No. 14/973,702, filed on Dec. 17, 2015.
Application No. 14/973,702 is a continuation-in-part of application No. 14/334,592, filed on Jul. 17, 2014.
Application No. 14/334,592 is a continuation-in-part of application No. 14/058,119, filed on Oct. 18, 2013, now abandoned.
(60) Provisional application No. 61/795,497, filed on Oct. 18, 2012.
(60) Provisional application No. 62/596,003, filed on Dec. 7, 2017.

(51) Int. Cl. G06Q 30/06

(52) U.S. Cl. CPC G06Q 30/0631; G06Q 30/0639

(57) ABSTRACT

A matching system identifies available matching items. A base item is determined from user input and/or a data store (e.g., a virtual closet). A virtual closet may contain information identifying each item previously purchased or otherwise owned by a user. Each base item is characterized by a plurality of specifications, such as color, pattern, style, type and brand. Available items are also similarly characterized. Matches are determined according to matching rules. Geolocation may limit recommended available items to the inventory of one or more particular retail establishments.

### RELATED APPLICATION

This application is a nonprovisional and claims the benefit of priority of U.S. Provisional Application 62/596,003 filed 7 Dec. 2017, the entire contents of which are incorporated herein by this reference and made a part hereof. This application is also a continuation-in-part and claims the benefit of priority of pending U.S. Nonprovisional application Ser. No. 14/973,702 filed 17 Dec. 2015, which is a continuation-in-part and claims the benefit of priority of pending U.S. Nonprovisional application Ser. No. 14/334,592 filed 17 Jul. 2014, which is a continuation-in-part and claims the benefit of priority of U.S. Nonprovisional application Ser. No. 14/058,119 filed 18 Oct. 2013, which is a Nonprovisional of and claims the benefit of priority of U.S. Provisional Application No. 61/795,497 filed on 18 Oct. 2012, the entire contents of which are incorporated herein by this reference and made a part hereof.

### FIELD OF THE INVENTION

This invention relates generally to e-commerce, and, more particularly, to system and method for a matching a base item with items available to a user based upon characterization criteria, matching rules and geolocation.

### BACKGROUND

Look, the world is a big place!! We are so inundated with television channels, shows, movies, music, apps, appointments, meetings, traveling, news and passwords to name a few . . . . It's limitless!! Just too much to keep up with! Are you tired of the hassles from coordinating travels, restaurant options, shopping options, and entertainment options? I am, I believe we all are. Well welcome your Virtual Concierge and Lifestyle Personal Assistant. A virtual assistant or platform that will manage the selection process, so you don't have to . . . as it's a nightmare. Virtual assistant or system that is continuously and proactively searching, researching, reminding, taking notes, managing, coordinating, scheduling, recommending, purchasing, learning, evolving, notifying, customizing channels around your every move and very interest by fulfilling boredom gaps, traveling gaps, based on your personal and business daily calendar, personal, business, and family information, your habits, likes, needs, directives, resting location and traveling location while you are freed to enjoy all what the world has to offer.

Your assistant in essence becomes a proactive thinker!!

This can all be done with or without any user intervention using semantic intelligence, artificial intelligence, machine learning and a cognitive computing framework.

Our vision is to create a centralized world where business marketing and consumer's needs and wants not limited to products, services, and entertainment options from all industries will be learned and managed for timely pin point systematic recommendations, reminders, and purchases based on priority and popularity with little or no user intervention. The assistance of such a system will significantly reduce marketing cost of businesses while significantly increasing B2C and C2B awareness of timely mutual interaction.

The invention is directed to overcoming one or more of the problems and solving one or more of the needs as set forth above.

### SUMMARY OF THE INVENTION

To solve one or more of the problems set forth above, in an exemplary implementation of the invention, a matching system identifies available matching items. A base item is determined from user input and/or a data store (e.g., a virtual closet). A virtual closet may contain information identifying each item previously purchased or otherwise owned by a user. Each base item is characterized by a plurality of criterion, such as color, pattern, style, type and brand. Available items are also similarly characterized. Matches are determined according to matching rules. Geolocation may limit recommended available items to the inventory of one or more particular retail establishments.

An exemplary computer-implemented matching system and method according to principles of the invention includes a base item identifier, which may be obtained from user input into a computing system or from a plurality of base item identifiers stored for a user, such as in a virtual closet. The virtual closet contains base item identifiers, and other information (e.g., images, product codes, etc. . . . ). Entries (e.g., input such as values/text) for a plurality of characterization specifications are associated with each base item identifier. These entries may have been input by a user or obtained from a data source, such as but not limited to a vendor's or manufacturer's database. Nonlimiting examples of the specifications are color, style, pattern, type, and brand. A database contains a plurality of available item identifiers, and for each available item identifier including entries for a plurality of characterization specifications associated with the available item identifier. The database may be a database for a particular merchant, a database comprised of data for a plurality of merchants, or some other data source or plurality of sources that provides the relevant data. A rules base (i.e., collection of stored rules) comprising a plurality of predetermined matching rules is provided (e.g., stored on a computing system). A matching engine (e.g., algorithm) applies a matching rule to determine if a base item identifier and an available item identifier are a match based upon the entries for the plurality of characterization specifications associated with the base item identifier and the entries for the plurality of characterization specifications associated with the available item identifier. A computing system (e.g., a user's smartphone) displays information for an available item identifier that is determined to match the base item identifier.

For example, a user's virtual closet may contain a base item identifier for a pair of men's black dress slacks. A user may seek a shirt that matches the slacks. The user may be at a particular store in a mall. The applicable rule may specify a white shirt for mens dress black socks. Available items may correspond to white shirts available in the particular store. Identifiers and other information (e.g., an image, brand, location within store, whether in stock, and listed price) may be displayed on the usre's computing device.

Furthermore, as additional purchases are made, the user's virtual closet may be updated. Such updates may be automatic through information supplied by a store's loyalty program and/or manual by user entry.

### BRIEF DESCRIPTION OF THE DRAWINGS

The foregoing and other aspects, objects, features and advantages of the invention will become better understood with reference to the following description, appended claims, and accompanying drawings, where:

FIG. 1 is an exemplary nonlimiting flowchart for steps of a method according to principles of the invention; and

FIG. 2 is an exemplary nonlimiting flowchart for steps of a method according to principles of the invention; and

FIG. 3 is an exemplary nonlimiting flowchart for steps of a method according to principles of the invention; and

FIG. 4 is an exemplary nonlimiting flowchart for steps of a method according to principles of the invention; and

FIG. 5 is an exemplary nonlimiting flowchart for steps of a method according to principles of the invention; and

FIG. 6 is an exemplary nonlimiting flowchart for steps of a method according to principles of the invention; and

FIG. 7 is an exemplary nonlimiting high-level schematic for a user interface for a system according to principles of the invention; and

FIG. 8 is an exemplary nonlimiting high-level schematic for a example use case for a system according to principles of the invention; and

FIG. 9 is an exemplary nonlimiting flowchart for steps of a method according to principles of the invention; and

FIG. 10 is an exemplary nonlimiting high-level schematic for a user interface for a system according to principles of the invention; and

FIG. 11 is an exemplary nonlimiting flowchart for steps of a method according to principles of the invention; and

FIG. 12 is an exemplary nonlimiting block diagram for a system according to principles of the invention; and

FIG. 13 is an exemplary nonlimiting flowchart for steps of a method according to principles of the invention; and

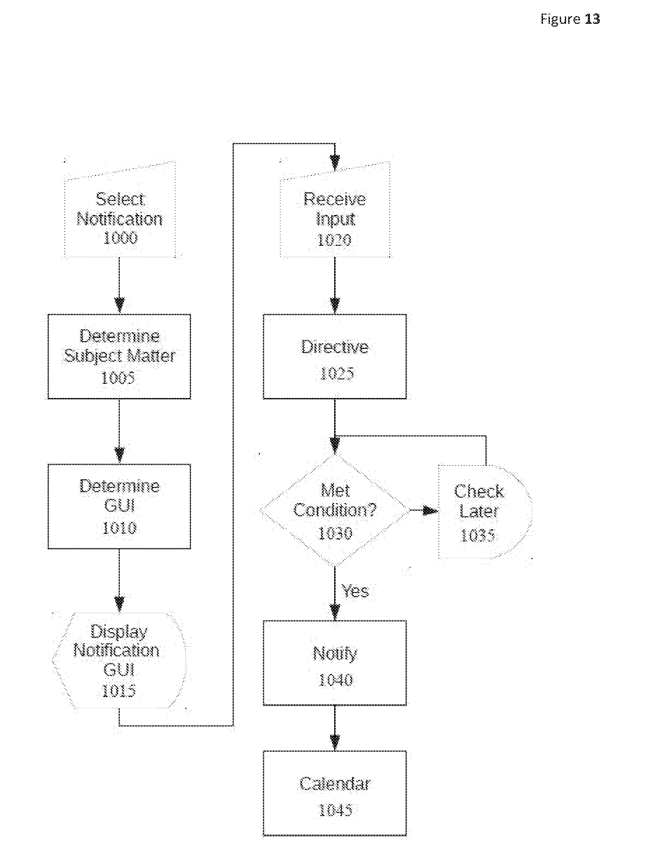

FIG. 14 is an exemplary nonlimiting flowchart for steps of a method according to principles of the invention; and

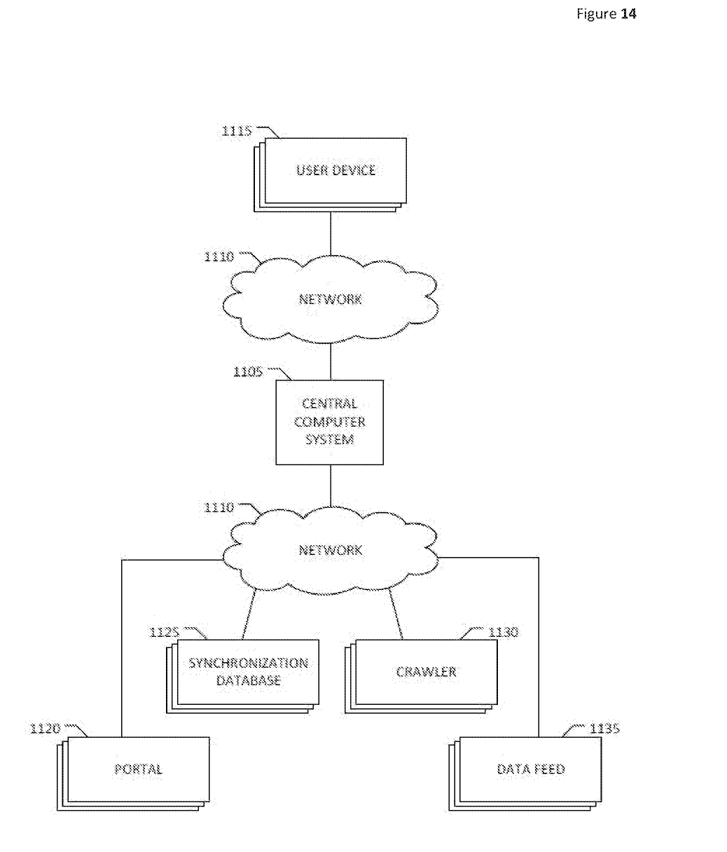

FIG. 15 is an exemplary nonlimiting flowchart for steps of a method according to principles of the invention; and

FIG. 16 is an exemplary conceptual illustration of a smartphone user interface for a method according to principles of the invention.

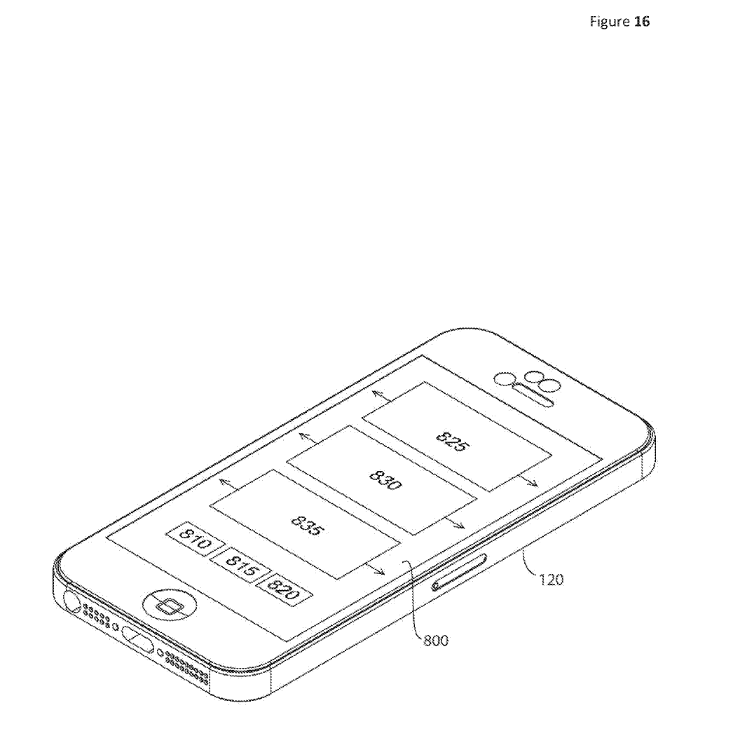

Those skilled in the art will appreciate that the figures are not intended to be drawn to any particular scale; nor are the figures intended to illustrate every embodiment of the invention. The invention is not limited to the exemplary embodiments depicted in the figures or the specific components, configurations, shapes, relative sizes, ornamental aspects or proportions as shown in the figures.

### DETAILED DESCRIPTION

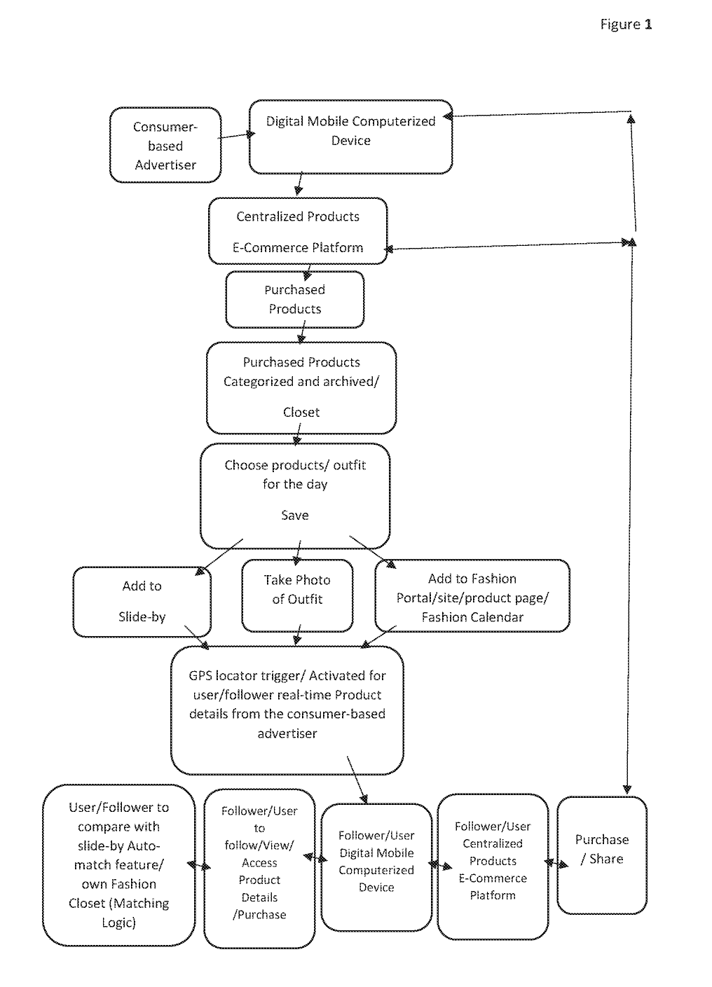

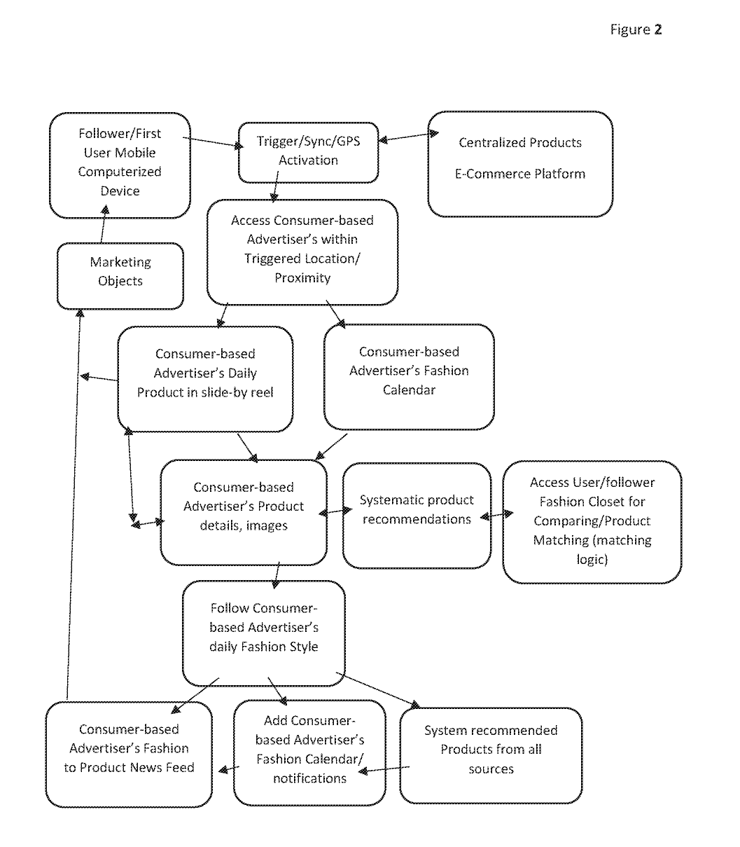

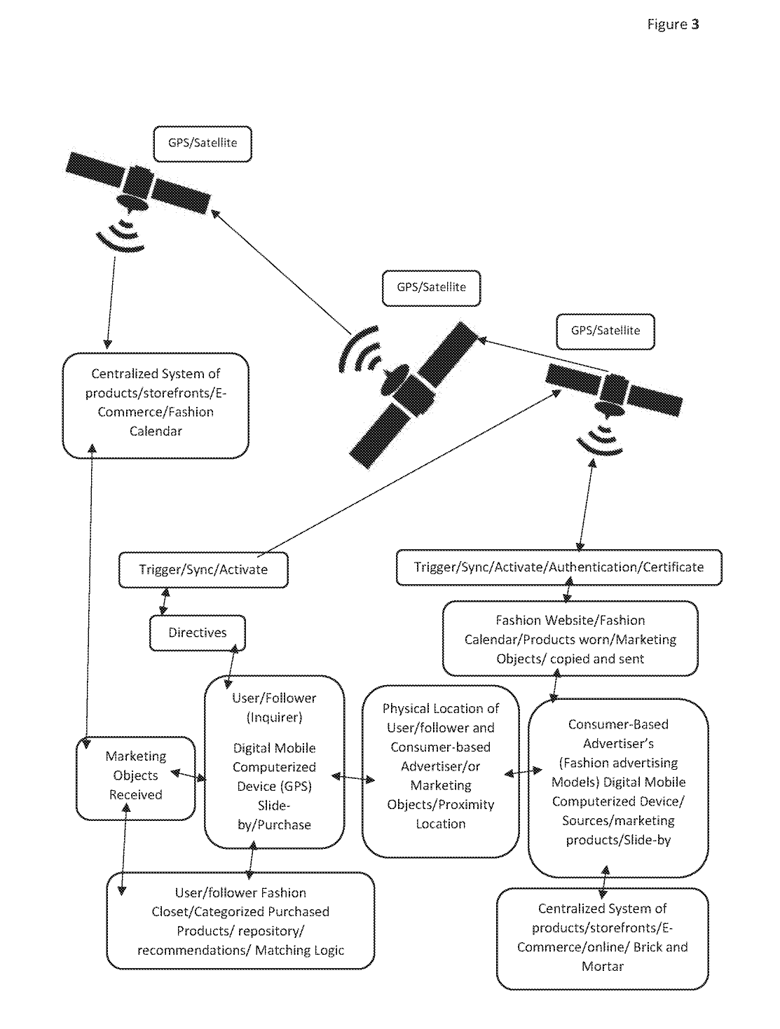

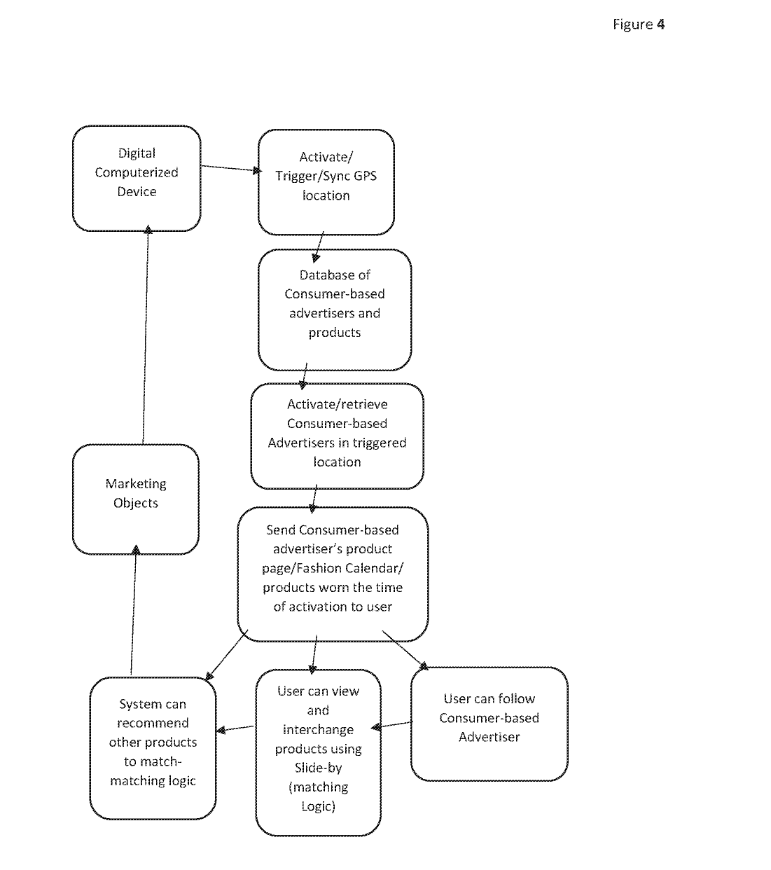

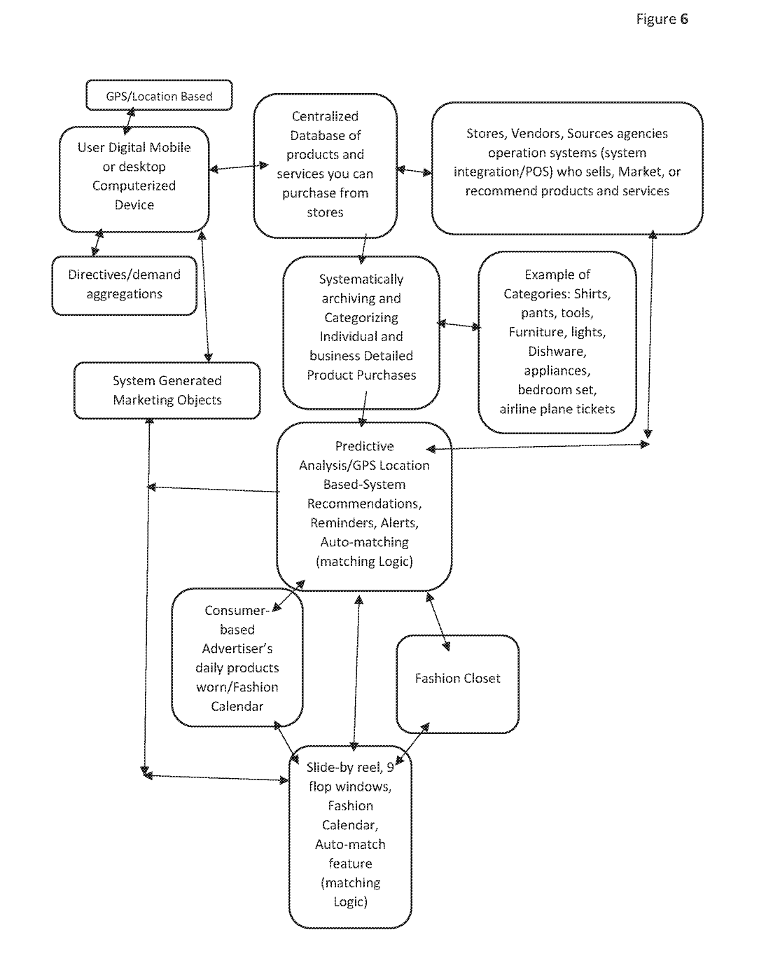

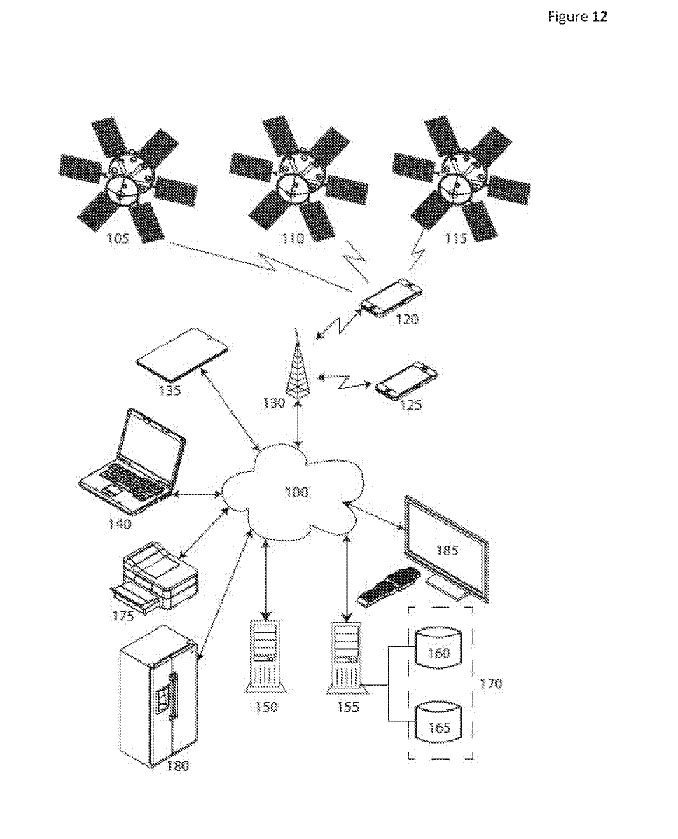

Multiple windows for random product generating and displaying and matching logic for Slot Machine Mode auto-match (rotation), slide-by reel, strips, or 9 flop or any arrangement: (reference FIGS. 1-6 and FIGS. 10 and 11, 12).
1. Women
   1. First windows: Tops, Shirts, T-shirts, Dress Shirt
   2. Second Window: Skirts, Shorts, Pants, Jeans, dress pants
   3. Third Window: Heels, Wedges, Sandals, Pumps, Sneakers,
2. Women Sports
   1. First Window: Tops, T-Shirts, dri-fit (athletic brands)
   2. Second Window: Tights, Shorts, Skirts, Sweat pants (athletic brands)
   3. Third Window: Running, training, basketball, sneakers,
3. Button to choose Nike, Adidas, Reebok, Under Armor, Converse, New Balance
4. If user Chooses Dress, Jumpsuit, Rompers (default to 2 windows only)
   1. First Window: Any Dress, (evening, day, summer, wedding, etc) Jumpsuit, Romper,
   2. Second Window: Heels, wedges, sandals, Pumps
1. Men
   1. First windows: Tops, Shirts, T-shirts, dress shirt
   2. Second Window: Shorts, Pants, Jeans, dress pants, slacks
   3. Third Window: Basketball, Sneakers, Dress Shoes
2. Men Sports
   1. First Window: Tops, T-Shirts, dri-fit (athletic brands)
   2. Second Window: Tights, Shorts, Skirts, Sweat pants (athletic brands)
   3. Third Window: Running, training, basketball, sneakers,
3. Button to choose Nike, Adidas, Reebok, Under Armor, Converse, New Balance

All windows can be with or without borders and swipe left or right or up and down or flip either direction etc . . . .

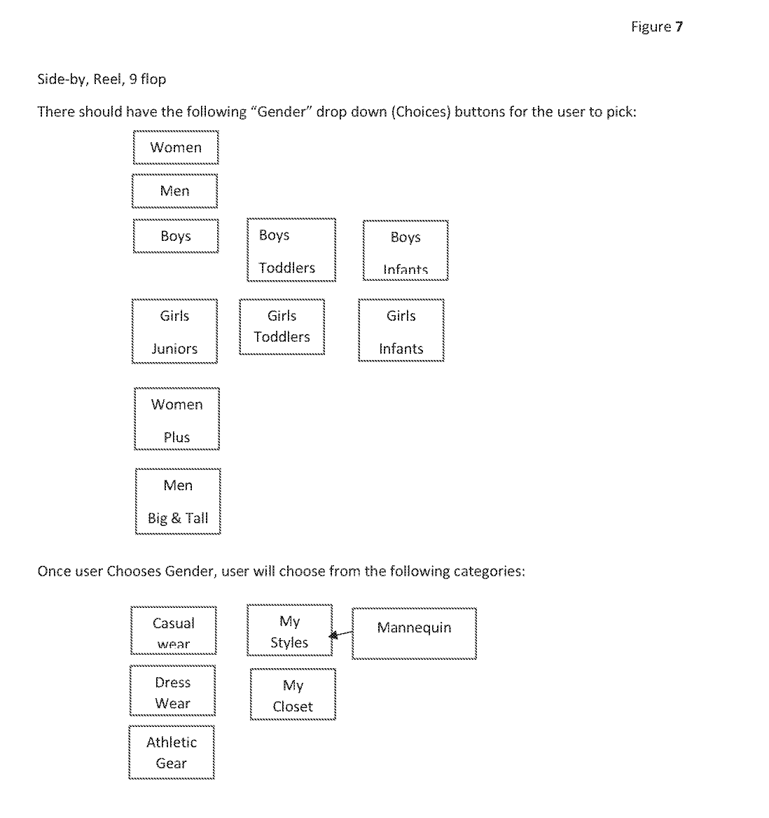

Database of Multiple Color Shades to Primary Colors and Matching Logic for both the Regular Search Engine and the slot machine mode, Slide-by strips, 9 flop strips, or Reel within the invention (reference FIGS. 1-7 and FIGS. 9 and 10,11,12) Matching logic can be performed using a graphical (Graph) database such as AWS Neptune Database

Under the regular search engine for matching colors and similar products with the same color:

There needs to be a database of all colors listed under each primary color in regards to basic product searching.

When a user searches for an item based on any primary color listed, the system should display requested products in all colors listed under each Primary color provided.

When a user finds a color he/she likes or is looking for, then we will provide them an second way to match. (all color names are read as keywords in the detail page of the product)

The user will be able to select the product and the product will display “check mark” which means that product has been chosen to Match. The algorithm reads the color or colors selected from the product.

Once the user has “check marked” the product and the user has the color they are looking for, the user may select the “match it” button on the website or app, and the system will display every similar product for example “Ivory Shirt, Baby Blue Pants, Copper Shorts” of the specific color on the screen for viewing. (Using Keyword Algorithm)

This is created so users can find a specific color of a product they need and they will now know the name of that specific color they seek. (very unique, and has never been done before)

If the user selects just the primary color in our system, then display products available in just the primary colors name (this means there is “No Mention” of the descriptive color of shades listed under the primary color in the product detail page) only primary!

Under the Slide-by for automatic Matching colors:
When searching for a product of a specific color, the automatic matching feature should display a product with the specific name or from the same group of colors to display
If the First window displays a product with a specific name for example “Rose-Red, Maroon, Cherry-Red in the detail page, if the middle or bottom window decides to display a product, the system should display a product with the same specific name color. (however, under the matching rules below, the system does not always have to display the same color . . . only when it decides for example to display Red, look for the exact specific name or very similar colors of the color group. (Group products with the same color code)
For example of what not to match, don't match up regular red with a Maroon color, they are too different. (only from the same group of a very similar shade)

Shades of White

White (1)

Pearl (3)

Off White (3)

Ivory (1)

Cream (2)

Vanilla (2)

Seashell (3)

Snow (1)

Splashed white (1)

Shades of Black

Black (4)

Ebony (5)

Onyx Black (5)

Jet (5)

Shades of Gray

Grey (6)

Gray (6)

Cadet Gray (7)

Cool Gray (7)

Silver (9)

Platinum (10)

Ash gray (7)

Gun Metal Gray (12)

Taupe gray (6)

Timberwolf (10)

Slate gray (7)

Battleship Gray (6)

Charcoal (8)

Shades of Blue

Blue (13)

Baby Blue (14)

Powder Blue (14)

Air Force Blue (22)

Sea Blue (14)

Blueberry (21)

Carolina Blue (14)

Dodger Blue (20)

Duke Blue (13)

Cyan (16)

Electric Blue (16)

Teal (17)

Light Blue (14)

Midnight Blue

Navy Blue (13)

Oxford Blue

Royal Blue (20)

Dark Blue (13)

Sapphire (15)

Sky Blue (14)

Turquoise (16)

UCLA Blue (15)

Yale Blue (19)

True Blue (15)

Palatinate blue (13)

Marine Blue (14)

Aqua Blue (14)

Denim (18)

Jeans (18)

Shades of Brown

Brown (23)

Beige (25)

Tan (25)

Bronze (24)

Rust (24)

Buffalo (26)

Wheat (27)

Sand (25)

Khaki (25)

Coffee (26)

Copper (24)

Shades of Red

Candy Apple (28)

Red (28)

Crimson Red

Carmine (29)

Burgundy (29)

Maroon (29)

Oxblood (29)

Raspberry (28)

Cherry (29)

Tomato (29)

Wine (30)

Cardinal (28)

Ruby (28)

Scarlet (28)

Redwood

Rosewood (29)

Dark red (29)

Venetian Red (28)

Shades of Violet

Purple (32)

Light Purple (36)

Lavendar Floral (32)

Red-Violet (35)

Violet (31)

Indigo (31)

Plum (32)

Fandango (35)

Tyrian (32)

Thistle (33)

Amethyst (32)

Orchid (36)

Dark-Purple (31)

Mauve (33)

Fuchsia (34)

Magenta (34)

Rose (34)

Shades of Yellow

Yellow (37)

Amber (39)

School Bus Yellow (39)

Gold (40)

Selective Yellow (39)

Maize (41)

Naples Yellow (41)

Mustard (38)

Mikado yellow (39)

Shades of Orange

Orange (42)

Orange-red (44)

Orange Peel (42)

Carrot (42)

Tangerine (42)

Pumpkin (42)

Rust (43)

Burnt Orange (43)

Dark Orange (43)

Shades of Green

Green (45)

Light Green (45)

Dark Green (49)

Apple Green (45)

Bright Green (45)

Lime (50)

Emerald (51)

Hunter (48)

Fern Green (48)

Lawn Green (45)

Olive Green (52)

Neon Green (45)

Shamrock Green (46)

Mint (46)

Sea Green (46)

Jungle green (46)

Forest Green (49)

Moss (47)

Jade (53)

Shades of Pink

Pink (54)

Salmon Pink (54)

Dark Pink (55)

Carnation Pink (54)

Brink Pink (55)

Ultra Pink (55)

Hot Pink (55)

Rose Pink (55)

Deep Pink (55)

Mexican Pink

Magenta (55)

Fuchsia (55)

Shades of Denim

Denim (56)

Jeans (56)

Shades of Multi-Color
More than two colors of any color (Ex. If Red and Black in the details, then use group number 28 and 4)
This can be used if the user asked for a red and black shirt.
Random Search with no specific product to match:
By Default, for men:
The first window will search for any T-Shirts, Sports t-Shirts. Nike, Under Armor, Reebok, Adidas
The middle window will search for any Shorts or Sports Shorts
The bottom window will search for sneakers, running shoes, training shoes, and basketball shoes
By Default, for Women:
The first window will search for any Tops and Shirts
The middle window will search for all shorts and skirts that do not mention sports brands like Adidas, Nike, Reebok or Adidas
The bottom window will search for Sandals, Heels, Pumps, Wedges

Auto-Matching Rules (matching logic): System will determine what products to search and display depending what category the user is currently searching whether its Women, Men, boy, girl, Sports. (if searching Sports, it still needs to determine Women, Men, Girl, or Boy). (button is triggered to initiate) Within the matching logic or rules, All products or services within the Locked or unlocked strips, reels, or windows can be matched by category, sub-category, brand, price, discount, matching parts, recommendations, reminders, financial obligations or any other associated product or service. Random display generated from slot machine mode or 9 flop or any other arrangement. In slot machine mode, strips or reel rotates, generate, and spin while collecting associated matching products until matching products are found. Matching logic within the invention may also be executed or performed within any search engine. Matching Logic may also be performed using a graphical (Graph) database such as AWS Neptune database (reference FIGS. 1-7 and FIGS. 9 and 10,11,12)
System will spin all 3 windows: User Spinning all 3 windows, all unlocked. By default, the System will stop on any color shirt, style shirt, whether it's a stripe, a multi-color, or a solid color. And whether a T-Shirt, a button up, or a Collar etc. . . .
   1. Top window will stop first
After the first window stops spinning:
   1. The middle window will read the color or colors and brand the first window displayed
   2. The middle window will decide whether it is a multi-color, a stripe, or one solid color (this is determined by the description . . . if details read more than one color, then the product will read as a multi-color. If it mentions the word “Stripes”, then it will read as a stripe shirt).
      1. If the First or top window reads as a Stripe or Multi-color when it stops, then the middle window will automatically default to all solid searches of the next product to be displayed.
         1. Middle window will search for solid Shorts, Jeans, Skirts, Pants, whether its for Women, Men, Girls, or Boys products
         2. Middle window will search any of the colors mentioned in the details of the strip or multi-color product that displayed in the first or top window and display it as a solid color product in the middle window. (Shorts, Skirts, Jeans, Pants)
         3. If a Sports T-Shirt like Nike, Adidas, Reebok, and Under Armor is displayed in the first window, then the middle window, if displaying “Shorts” only, will search for the same brand of shorts to be displayed in the middle window.
         4. For Women and Girls, If the first window displays a “Top” or “Dress Shirt”, and don't mentions any sports brands like Nike, Adidas, Reebok, or Under Armour, then middle window should not display any Sports shorts.
      2. If the first or Top window reads as a soild color shirt or one color with no addidtional colors, then the middle window can automatically default to all solid or multi-color products to be displayed in the middle window. (Middle Window color does not neccesarily have to match the first window if first window lands on solid color).
After the first two windows stop spinning and has displayed its products:
   1. The Bottom window will read the details of the first window and if the details read as a dress shirt or shirt, or Top, then the bottom window will search for Dress shoes or dress boots in any of the colors in the details of the product displayed in window one and all black dress shoes, tan shoes group (25) and all brown dress shoes. (if any sports brand is read in the details, then default to Sneakers, Running shoes, Training shoes, Basketball Shoes)
   2. If the Bottom window before it stops spinning reads that the details in the first window is any T-Shirt, any Top, any sports shirt, Nike shirt, Under Armor shirt, Reebok shirt, or Adidas shirt for Women, Men, Boys, or Girls, then the bottom window will search and display Sneakers, running shoes, training shoes or Basketball shoes in any one of the colors that is in the details of the shirt in first window, black color shoes and white color shoes.
      1. The bottom window will also look for the brand name (Nike, Adidas, Reebok, Under Armor, New Balance) in the first window T-Shirt details and display the same brand name brand of Sneaker, Running shoe, Training shoe, and Basketball Shoe in the bottom window.
      2. Always match black Men, Women, Girl, and Boys shoes with any color (Always mix in the matching process
9 flop matching logic uses 9 windows to match up products. For this process, the windows, strips, or reels during the auto-match will stop one at a time very similar to the slot matching mode except windows can flip flop in order. Any Window, Strip or Reels can stop first and the rest of the windows, strips, or reels will use the matching logic and color code rules one after the other until all windows, reels, or strips have stopped for a complete match (random display generator matching).
   1. Each window will have a specific product to match for each stop or everytime the match it button is triggered. One will match just shirts top, etc., one just pants, shorts, skirts, one just shoes, heels, one just hats, one just glasses, one just jewelry, one just beauty, one just Fragrance, one just jackets, coats.

When user is selecting a product outside the Slide-by to match within the Slide-by, then have products default as mentioned below: (reference FIGS. 1-7 and FIGS. 9 and 10,11,12)

By Default, for men or boys:
All T-Shirts, Sports t-Shirts, Nike, Under Armor, Reebok, Adidas jackets, coats, Dress shirts, collar shirts chosen will be displayed in the first window for matching
All Shorts, Sports Shorts, jeans, pants, sports sweat pants chosen will be displayed in the middle window for matching purposes
All sneakers, running shoes, training shoes, basketball shoes, dress shoes chosen will be displayed in the bottom window.

No other products like Belt, Hat, Jewelry can be matched in the Slide-by (send error message that product can not be added)—These products can be added to the 9 window and 6 window matching system when applicable.

By Default, for Women or girls:
All Tops, Shirts and Jackets chosen will be sent and displayed to the first window for matching
All shorts, skirts, pants, jeans chosen will be sent and displayed to the middle window for matching
All Sandals, Heels, Pumps, Wedges, sneakers, shoes chosen will be sent and displayed in the bottom window.

When a dress is chosen, eliminate the first window, default the dress to the second window, and keep the third window to match up heels, sandals, wedges, pumps, shoes.

No other products like Belt, Hat, scarves, Jewelry can be matched in the Slide-by (send error message that product can not be added)—These products can be added to the 9 window and 6 window matching system when applicable.

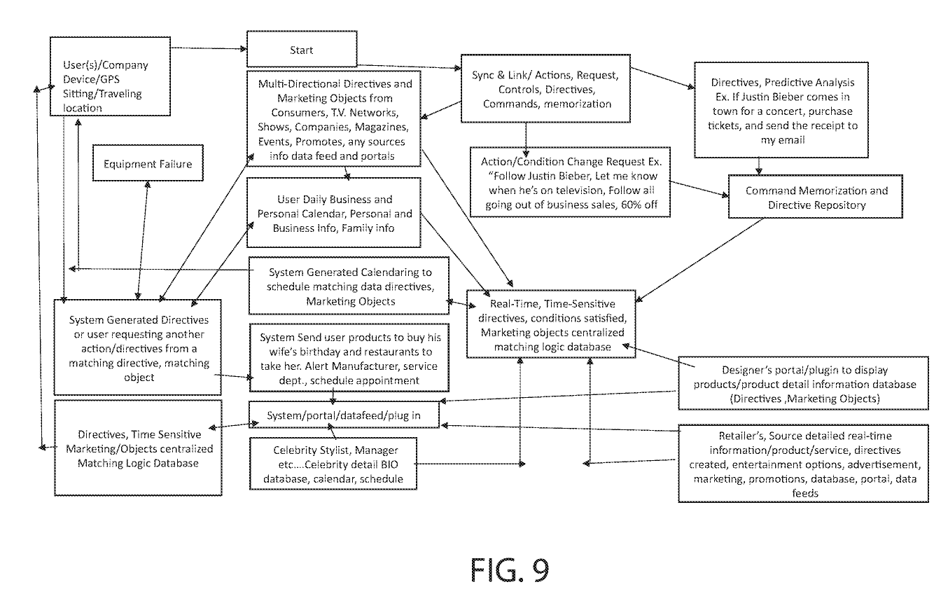

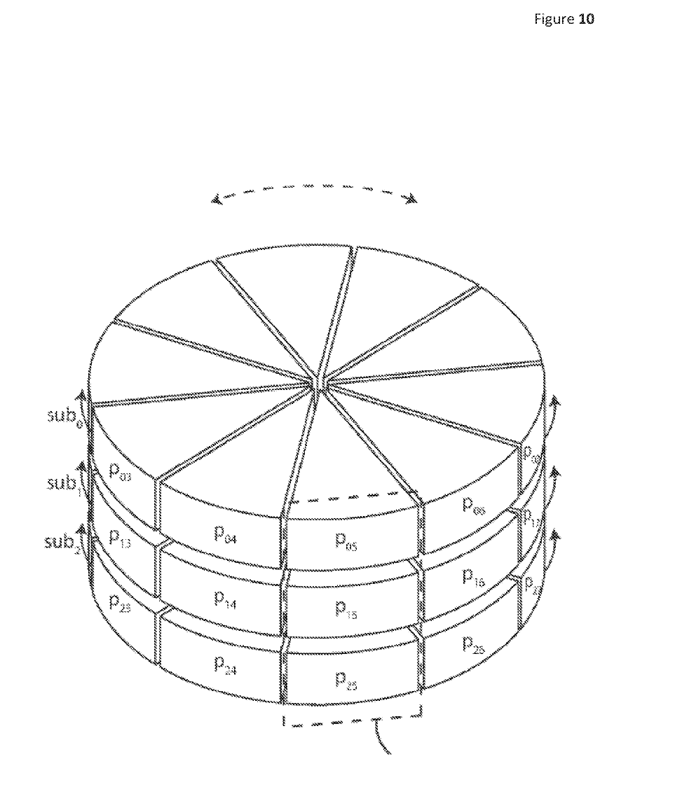

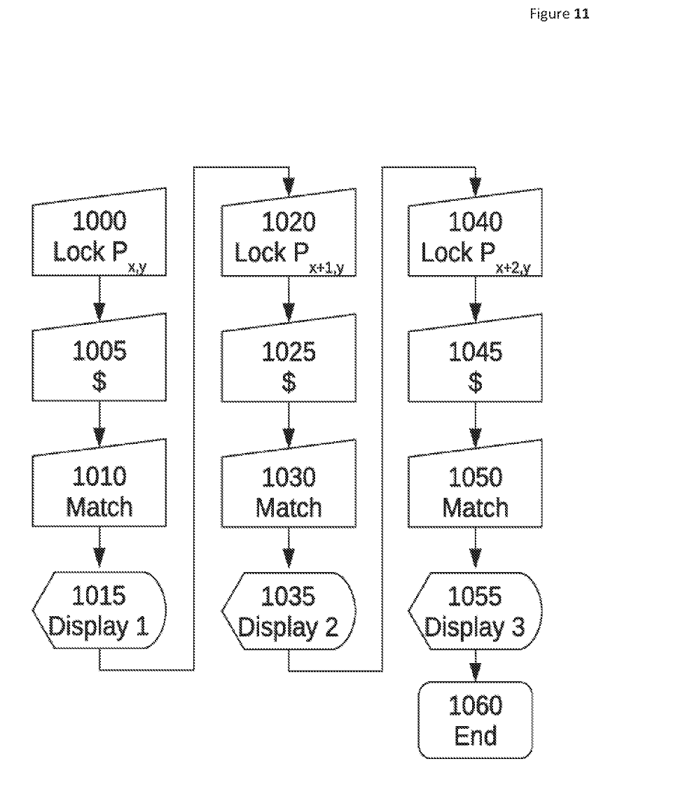

When the user locks a product within the Slide-by and hits the auto-matching button: (Gender product determination will depend on what gender the user was under when they accessed the Slide-by or picked their first product to match) (reference FIGS. 1-7 and FIG. 9, 10,11,12)
If a user locks a product from the first window, the middle window and bottom window will start spinning.
Match according to the matching rules mentioned above
If a user locks a product from the middle window, the first and bottom window will start spinning.
The first window will stop first and read to see if the middle window has a sports brand and will see if the middle window details read Stripe. Multi-color, or one solid color.
Match according to the matching rules mentioned above
The bottom window will match according to the matching rules mentioned above
If the user locks a product from the bottom window
The first window will determine by reading the details, if the shoe is a dress shoe, boot, Sneaker, running shoes, training shoes, basketball shoes, heels, wedges, sandals, pumps
Then read the color from the details from the bottom window and display a shirt according to the matching rules
If the user locks more than one window, then match according to the matching rules mentioned above
User can also match a product or service by selecting a match it icon or locking the specific product from a web site of multiple products and the system will then systematically match that product against other products within one or more vendors or storefronts according to the matching logic. Matching logic can have filter that match from purchased archived products of the user or their fashion closet. FIGS. 9 and 10
Adding to the matching logic with budget filter (FIGS. 10 and 11): system can match up products with or without locking the product according to the matching rules and invention. Budget button can be used to set and entire budget limit for any product being displayed in reels or windows of displayed products. Budget Limits can be set for an aggregation of products from the same or different storefronts, websites, datafeeds, etc with without matching of the products. For example, if the user only have a budget of $1200 dollars, the user can by button or voice command tell the system to find a shirt, pants, shoes, samsung T.V., and concert ticket and plane ticket, and keep the entire dollar amount under $1200 dollars. The system will the learn and configure what the directive was asking and search for products mentioned using the matching logic. If the user likes one or more of the products and do not like the rest for whatever reason, the user could then lock the product and then hit the match it button, or use voice command to tell the system to re-configure and search for more matches to still keep the prices of the products under budget. The process can be repeated until the condition is satisfied. Budget can be integrated into the slide-by or reel within the invention or any search engine. The budget is associated with a locked product. Matching logic may also be performed using a graphical (graph) database such as AWS neptune database.

All features within the invention can be integrated into the slide-by or reel feature within the invention.

Consumer-Based Advertiser (Fashion Advertising Model) FIGS. 1-5, 6,10, 11

When matching products from the consumer-based advertiser feature, the advertiser can match up products from their closet. The user can sync or ping a consumer-based advertiser in real-time to see what they are wearing from multiple categories and compare or match the products worn by the consumer-based advertiser to products saved in their archive of purchased products or personal fashion closet. User can also compare or match products shown on Television or worn by celebrities to their own in their personal Virtual fashion closet or archive of purchased products or services.

Consumer-based advertiser or Fashion Advertising Model: within the invention, if the user trigger, ping, activate or sync an area to find out information on a specific product or products that the consumer-based advertiser is wearing or if the person they are inquiring about is advertising products for the system . . . the Sync or activate button will trigger the GPS location of the user. It will then trigger the phones or devices of anyone in that specific location or a specific radius of the user or follower or trigger person and display all profiles and products selected to be worn by the Fashion Advertising Model from the virtual closet that specific day and time. If any Consumer-based Advertisers are found within that specific location, the system will them capture the products worn and entire profile of the consumer-based advertisers or fashion models and display it on the screen for availability of the user that pinged, synced or inquired about the consumer-based advertisers products that were worn on that day. If the user inquiring wants to follow the consumer-based advertiser or fashion model for future awareness of products worn, details of those products, pricing, or store info in the future, they can then friend the consumer-based advertiser. Consumer-base advertiser gives permission to any user to inquire or follow products they wear via system.

User can also trigger, activate or sync the location they are currently inside and receive product information for matching purposes or system generated recommendation, pricing, or matching purposes from their own personal archived purchased products or fashion closet. The trigger can also be systematic and products can be recommended based on location, GPS etc. . . . .

A consumer-based advertiser is a human fashion advertising model that advertises products they purchased from the retail store, designers, or vendors to earn money or commission by wearing the products.

Any users (follower) can save styles as favorites and the user could have the system display the styles in there News feed all the consumers advertisers in the network who are wearing their favorite style to see different looks and the user could also see different products for sale of their favorite style. Users could take a picture of outfit and user could save picture of them wearing it. Each product in the picture can be added to the slide-by or 9 flop for interactive matching.

Any product worn in picture can still be purchased separately. Our system can place them all in Slide-by, auto-match, 9 flop, or cart for viewing and purchasing.

9 flop uses a 9 window auto-match technology with similar matching logic technology as the slide-by with or without the borders. Products in each window can flip-flop before stopping and adding the matching product or use any other variation of displaying. Reference FIGS. 1-6 and FIGS. 9 and 10,11)

Knowing product information from any location in real-time: FIGS. 1-4,6,10,11 In addition to a Consumer advertiser, the user can find out the price of anything is real-time by initiate a trigger that will pull up objects at the single location based off the GPS location. Companies or sources will have categories of purchases archived and can use those products for displaying at a location of their choice. This is done by portal or website. Whenever, someone or a user is in the location, the user can trigger products for purchase in that particular location to display on their screen, mobile phone, or device. User will have portal and fashion virtual closet or a system that archives all purchases to categorize it or organize it in the correct area within the household and display products and match up products via the slide-by technology. Also you can know about the other locations that you are not currently. Locations can be in or outside.

Trigger the location: When a user triggers his location by using a trigger button on the digital computing device, the GPS location of the user will be activated. The GPS location will form a specific radius, for example 50 feet or 100 feet and trigger anyone or in this case any digital computing device that is located within the radius at the time of the initial trigger that also is a part of the universal centralized system within the invention or that is also a part of the universal virtual closet or universal system of archived purchases. Once the other computing devices are triggered, the system will access the products the Fashion Model selected he or she were wearing the particular time and day and the profile of that Fashion model, and then the system will display the products worn onto the followers digital computing device at the triggering event. The products selected at the time and day the user selects them, will exist or display to the follower or other user's digital device during trigger until another time or day is selected or until the user selects another product or outfit, or until the user select a “Stop wearing clothes” button for example. The Displayed products will be shown as a selfie and/or a picture and/or products displayed in a random or specific order or products shown into the slide-by auto-matching system. Fashion model will have a button to opt-in when they are ready to share products they are wearing to other users who triggers their location or to other users who wants to know what they are wearing.

In addition to the invention: Like a regular coupon notification when you are in proximity of a store that sells products or services, instead of sending a coupon, the system will send or display a product in the store for sale to compare or match with other products the user has archived or categorized in their virtual closet. Products can come with a discount. User can also get recommendations on products in the store if they retrieve clothes or products from their own closet. The process can be systematically or manual. Matching notifications can be based on exact location, Proximity of location, traveling location or destination based of calendar or GPS. System can read locations off google maps, navigation, and Uber-like technology, for example. Products can be mix and matched in the Slide-by feature or 9 flop. Recommended products will be pushed to the consumer based on but not limited to the algorithm reading the color, size, category, and product details of purchased products by the consumer and matching them with other products that are a great fit or similar to the product they purchased. The system also allow the consumer to request to see products that match a certain size dimension. For example, the user or consumer could record the measurements of a wall in their house and ask the system to find sectionals or couches that will fit the dimensions. This could be by color etc. . . . . In another example, the user or consumer could request to see Televisions that are similar dimensions to a certain T.V, stand they purchased in their closet or a T.V. stand that they are about to purchase. Reference FIGS. 1-6 and FIGS. 9 and 10,11)

Trigger Demand: Trigger demand can be initiated or created with any directive. This happens when marketing objects are released to users when a certain level demand or any level of demand is met from the condition of the singular or aggregated marketing directive. All Marketing objects and system generated marketing directives from any user which includes the company and the consumer, can be anonymous. Anonymously companies can give price reductions to only those who created the demand on a marketing object, other than making it public. The rest of the public will get it at regular price, these people will never know that it was on sale.

In another embodiment, users could text other users in real-time. Very similar to the consumer-based advertiser method to trigger or bing other users inside of an establishment to see whose is participating in advertising fashion products, users could also trigger or bing users in a location or establishment to see who is open for texting in real-time anonymously. All users have the right to give permission to other users to contact them. Once a user triggers the location, the user will see a list of all other users who are in the location that are members of the same invention or computer-based platform. Once the list appears, the user could anonymously have a conversation with any other user in the establishment or location. This is for shy users who hate to confront people who they may really want to get to know.

Businesses Satisfying Conditions and Bi-Directional System (Reference FIG. 9)

Business users, Merchants or Vendors directives can be created systematically for Marketing Object condition change awareness based on consumer marketing directives and marketing objects can be distributed manually or automatically once the directives are matched or based on the user's time-sensitive need.

In these claims, the company can create marketing directives to trigger when a specific condition is satisfied. A satisfied conditions for the business for example will be if a consumer selected a marketing directive to be notified when a specific product was 60% off. When the consumer or consumers associate this condition of 60% off with a marketing directive, then the businesses' condition is satisfied. Since both the business and the consumer are both looking for certain conditions to exist, this is called bi-directional marketing directives. This process can be done systematically or automatically. For Example, The business could have a “Shirt” that has been in inventory for 60 days and is considered “not selling”. If the business decides to issue a marketing directive to systematically send a marketing object to any consumer or consumers that also issues a marketing directive to be notified if that same “shirt” is 60% off, then this will be considered bi-directional marketing directives. Mutual matching satisfied directives! This matching directive can also come with an automatic purchase from the consumer if the consumer directive is met. It can also come with directions or shipping instructions on whom to send it to. Similar products alike “color or style” or similar price to the marketing object sent to the consumer can also be delivered to the consumer. A specific size of a product can be issued to those consumers with the same size in inventory. For the Business, a counter proposal from the consumer can be issued.

A user may specify or select a time and/or date on when they need to receive any satisfied marketing object.

Multiple price points can be set by the business. A specific shirt style even with different color and styles can be set a directives for marketing objects to go out to the right consumer marketing directive that matches. For example, the business could have 150 shirts total for sale to anonymous customer. 50 shirts set at 40% off and 50 set at 30% off, with 20 of the 150 being white shirts, 50 being black shirts, and 80 being blue shirts and with the same percentage of shirts divided up to small shirts, medium shirts, and large shirts. The marketing objects can be set to go out to those consumers who selected marketing directives any of the percentage discounts or price points. The merchant, business, or company can limit the amount of discounts or promos distributed.

Bi-directional directives can also systematically for entertainment options, television or any other industry or subject matter.

All bi-directional directives and matching of all directives to the user, consumer, marketing object, subject matter, company, vendor, source or purchasing system can also be systematically generated, distributed, or satisfied using a graphical (Graph) database such as the AWS Neptune database.

### Consumer Based Advertiser

A user can be both:

Advertiser's functions
1. User Page to see purchases
2. User page to access closet button for each genre of clothing, jewelry, shoes
3. Clothes are added to closet from purchases
4. User function to take picture and save it on Page dated for the day picture is taken
5. Archive page that shows calendar for every day products were worn from purchases from stores which includes cost, address, directions and personal selfie or picture that was taken for each day of the month of products worn
6. Full Calendar will show days and when the day is clicked, it will show products worn that day for advertiser
7. Show users how many followers they are getting
8. Show user how many people have shared their profile with other friends
9. User page the shows how many views a user has viewed the user products or clothes worn for that day in the calendar and how many views, clicks, and purchases for each product worn and displayed that day.
10. Page showing how much user is getting compensated for clicks and purchases
11. Page that lets user access money through a “pay me” button after they reach a minimum of a $600 dollar payout.
12. Advertiser will have a button that gives them the option to make product they just purchased “public ex. Make Public button” where user can view products from their daily purchases. Other purchases worn for that day will have a button that says “make it public” to display for the day the advertiser will be wearing the outfit.
13. Page or portal to see who want to follow them
14. Button to accept followers
15. Likes and views on all products or outfits from viewers
16. Comments or blog page for each outfit
17. Public profile—should be accepted automatically
18. Public and private or both public and profile buttons to display products

Follower's (user, receiver) functions
1. Button to trigger (GPS)(exact address) and display all possible advertisers in the exact location of the follower (displays all advertisers photo or photo of advertised products from a selfie photo in SlideBuy format to view advertisers profile and user page once clicked. Products that are advertised that specific day will be shown first to follower. Once the follower clicks the photo of advertised products or outfit, he or she should be able to view products, stores they were purchased, and directions to get there.
2. Button where the follower can choose to follow the advertiser and be notified of products they purchase and made public for viewing to their followers only.
3. Button where if follower purchases clothes, then purchased product or products will be automatically categorized in the follower's closet in SlideBuy.
4. Follow button from “slynk page or button”
5. Must get accepted to follow before viewing page
6. Follower can access the advertiser's calendar page they are following. Must get permission to follow person first.
7. Follower can instantly view triggered products worn that specific day from the advertisers without getting accepted as a follower.
8. A button where they can add any of the advertiser's purchases as an individual product or an entire outfit of everything worn that specific day, to their cart for purchase or to their “favorite outfits” page.
9. Close buttons
10. Previous “back one page button”
11. Button to share with contacts or friends (Facebook, Instagram, contacts from phone)
12. Purchases tied into referral program
13. Like buttons on all outfits and products
14. Can comment on outfits
15. Must get accepted as follower before you user can purchase
16. If you makes a purchase, then user automatically gets accepted as a follower to the advertiser. (prompt ex. You are now following “Lola”)

New Search within Slide-by:

Any new searches within the Slide-by will find all similar products and match according to the matching rules. May use a graphical database.

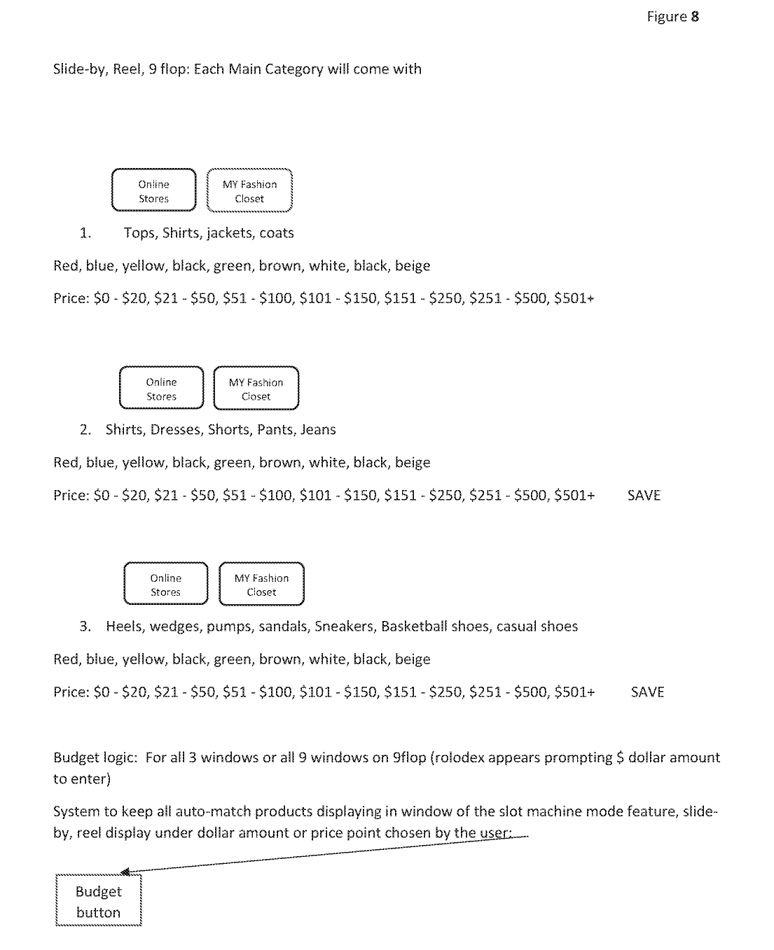

Capturing images and product details for systematic matching purposes and financial planning, advising, virtual fashion closet, archived purchased products and recommendation: Reference FIGS. 1-10,11

System captures and saves products and services from the centralized system and repository of a family of vendors and file them into categories for the user. Example: if the user purchases a shirt, pants, bike, airline ticket, concert ticket and hammer, the system will save images, product and service details and file it away in the user's personal closet, tax filing, and financial planner and just the category for which it belongs for tax purposes, financial recommendations, financial advising, matching purposes, recognizing saving or spending habits amongst a unlimited of other things. Features will be a part of artificial and semantic intelligence and machine learning with the current invention. All features can be systematic and automatic with or without user intervention. Our vision is to create a centralized world where business marketing and consumer's needs and wants not limited to products, services, and entertainment options from all industries will be learned and managed for timely pin point systematic recommendations, reminders, and purchases based on priority and popularity with little or no user intervention. The assistance of such a system will significantly reduce marketing cost of businesses while significantly increasing B2C and C2B awareness of timely mutual interaction.

System can periodically read calendars of the user to look up Flight info to determine the city, state, and country the user has scheduled a flight. System will also determine the location of the hotel the user will be staying. System determining flight information and hotel information from user can also be read without reading the calendar. Since the user will be purchasing airline tickets and hotel stay from a centralized system of all products and services from multiple industries, the system will record information of these purchases to determine where the user is going or staying. System can also record information, dates and times of other purchases for that particular day or any particular day to determine everything that user will be doing. For example: the user may purchase a concert ticket in advance, make reservations for a restaurant, go to a night club, Wedding, etc. . . . . Depending where the user is going, what tickets they purchase on those days through the system, night club they may be going to, the system will perform predictive analysis and recommendations to send options of clothes the user might want to purchase on that trip. For example: Las Vegas, the system could send different bikini or swimwear if the trip was determined to be in the summer time. The system can also send matching outfits, shoes etc. . . . to the user to match up clothes or shoes they previously purchased from the Slidebuy system that was in their virtual closet with other clothes from one or more merchants or retail stores. The system could also just systematically select outfits for the user directly from their closet. The system could send movies the user might like for their flight to Las Vegas during the boredom gap from the flight time of the trip. All without the intervention of the user which includes the consumer and the company or source. System can also know where the user is traveling, determine weather, and then start recommending clothes to wear during the duration of the trip. Basically packing the user's suitcase based on known intelligence within the system. For example, events purchased and scheduled within the centralized system, weather etc. . . . . The system will know the route they might be traveling to get to their hotel to notify them of things that are interesting to them or they need to do along the route based off directives the user selects or voice commands. System generated recommendations and predictive analysis based off purchases, calendar info, schedules. AI and machine learning. Recommendations, reminders can be based off any topic, information, industry, product and services from the centralized system.

Also, when someone makes a purchase at the stores physical location, please tie what is purchased using the stores reward system (phone number of customer) which is linked to our system to recognize customer and products purchased (via product code) to add products purchased to their virtual closet. once the phone number is entered and the product code is scanned, the system will recognize the product detail online within the invention and give the customer the option to add the product(s) to his or her own virtual closet or repository of archived previous purchases or send them to a family or friend who is captured in the mannequin system.

Virtual Closet (Follower interchanging products from their own virtual closet) newfeed:

The Virtual Closet can also be used when a follower finds a Fashion Advertising Model (some who wears their clothes previously purchased from the centralized system of products) from a news feed (like Instagram and Facebook), the system can recognized those products worn for the follower and send them to the Follower's Slide-by matching technology. Once the product worn from the Fashion advertising Model are in the Slide-by matching technology of the follower, then the follower can access his or her own closet to see the products worn by the Fashion Model matches or looks side by side with products from his or her own virtual closet. This technology works because the Fashion Model always takes a picture of themselves before posting and the Fashion Model selected what they were wearing when they posted the picture on the news feed of the social media. The system will then recognize it for the follower.

System's virtual closet and other features can integrate with the websites, rewards system, check out systems, or point of sales systems of vendors and other companies. For example: If a user purchased a product from a vendor's website or stores or within the centralized system within the invention, the product that was purchased can be sent as an image and product details to the user who bought the product or to the person's virtual closet who the user wants the purchased product to populate and categorize. User will have option “button” for the product purchased to categorize into their own virtual closet or archived purchases or a friends or family's virtual closet or archived purchases by prompting the contact list of friends and push a button that allows that product purchase to go to the friend's or contact's virtual closet or repository of archived purchases. The button will also come with a snooze button that tells the system to delay the message, push the product(s) to their friends or family member's own virtual closet or repository of archived purchases and options to give the distribution or notification of the product purchased at least for example 5, 10, 20, 30 days before alerting the friend or family member about the product. Then the user who For example, If the user is buying a product for his girlfriend's birthday a month from now, the user will have the option to delay the response for 30 days that will ask his girlfriend if she would allow this product to be categorized in her own virtual closet. The girlfriend or recipient will have a button “accept” that allows her to accept or reject. (prompting message sent with product) user's product or service info may be categorized in the financial system or tax organizing system within the invention for correct and accurate categorization.
1. Product information, images can also be captured by credit card, merchants services, gift cards, reward cards, rewards system, coupons to be categorized to the user's Virtual closet or archive purchases within the invention.

System or platform can use inventory information and data feed to promote or market products and services automatically to consumers without user intervention. If the company has an overstock of any product or have a product that has not sold after a certain period of time for example 60 days, system can be set through triggers to set out product details to the right target market who issued a directive to get that product at the condition they requested. If the company set in our system or theirs to automatically discount one or more products a certain percentage after 60 days, the system could systematically distribute these products or services to the correct target market based on if the user(s) chooses a system generated directive or action to be notified when a product or service drops a certain price point, or when an directive or action of the product or service conditions changes to satisfy the user, or when the condition requested by the user change is private or public knowledge within a certain time or for the very first time, or if the condition of the product requested already exist. For example, if a user chooses to select or create a directive or action to be notified when a specific shirt price point drop at a certain price, if that product from that specific retail company that has that specific shirt in their inventory or any company that has that shirt in their inventory selects to systematically have filters or triggers set to drop the price a certain percentage based on an aggregation or singular demand to have that price dropped to a certain percentage by the user(s) or based on expiration date and trigger date to automatically have that product or service price dropped, the system or platform will systematically send the notification to the user(s) who have selected the action or created the directive to be notified. The system or platform will systematically schedule events like concerts, comedies, movies tickets, or any entertainment options in the user's calendar and can purchase these items at the same time. User's credit card information will be saved in the system for purchases. User chooses directive to have system automatically purchase product or service on demand or when it's first available for purchase.

System can also send the product that is reduced in price or in stock to the user's auto-matching Slot Machine Mode feature or product reels with the correct product size and color for product matching recommendations from the centralized repository of vendors or from the user's virtual closet or any other product categorized for the user.

Data Metrics are systematically, analyzed, and constantly read for both the consumer and the company to produce bi-directional, multi-directional real-time systematic recommendation, purchasing, marketing, awareness and managing using artificial intelligence, semantic intelligence, and machine learning. The system can then create directives and perform an actions based on a single personal data metrics or an aggregation of data metrics to be sent to any user both company and consumer. System can also deliver marketing objects based on data metrics. The system can systematically put together itinerary for the user and determine exactly where the user is spending the most money and the least money. The system could systematically evaluate the consumer's or user's spending habits and show them how to manage their money or determine how much money to save for a vacation of one or more people based of predictive analysis and also determine or recommend which products, services or vacation packages fit their budget based off how much money they make or based off how much they spend all to save money by a certain timeframe when such event or vacation is set to begin.

Proposed itinerary based on historical purchase/preferences for vacation or other travel purposes, business or personal.

Manual calendar entries can include entering the date your child starts school and the system auto recommends/reminds school clothes and supplies need to be purchased, birthdays and anniversaries.

Mannequin system, Virtual Closet and Universal virtual closet and archived system of previous purchases

Mannequin system will save clothing or shoe sizes, favorite fashion styles, birthdays, anniversaries, height, weight, or any other personal information for the user and any of their friends and family and integrate with the entirety of the existing invention. In one example, the Mannequin system can allow a user to search for pair of jeans or shirt in their exact size and tell the system to find every person in the system with their exact weight, height, pants size or any other dimensions that has taken a picture wearing those exact same jeans. This will give the user an opportunity to see what those specific pair of pants in this example looks like on another user with their exact same body dimensions. Each user will have the opportunity to take a selfie or take a picture to showcase everything that they said they were wearing that particular time duration or times, morning, day or evening when they select each product they are wearing from their virtual closet. System will capture product details image including and save it to the database. In another example, the mannequin system can be used with the entirety of the invention for a user to shop for family member's or friend's exact sizes of clothes or any other product and tell the system or through an action via the digital device to send it to the family member's or friend's personal virtual closet or archived purchases once the product is purchased by the first user. Once the product is sent, the user has the opportunity to accept or reject. If the family or friend accepts, the product will be automatically categorized into their own virtual closet or archive system for all purchases. The virtual closet or archived system for previous purchased products can all be universal. This system can work across all stores. Once a user makes a purchase at the point of sale device, the system can recognize the user via payment system, rewards system, reward card, phone number, visa, mastercard, Samsung pay, apple pay, american express etc and the products they purchased. Purchases made from a credit card can trigger the digital device or smartphone of the purchaser, find the image and product details of the product purchased in the specific brick and mortar department store for example or online store for example in our database and send it and display it to the user's digital device or smartphone in a list or queue. The system then gives the user the opportunity to save those products in its own virtual closet or send them to a family member or friend in which the purchased product was intended for so they can accept or reject it from their own virtual closet. Credit card or payment system can be linked to the bank and can send a notification to the user, which then sends trigger to the user's smartphone to display products. Our system can also be linked to the company's reward system or point of sales. The reward system can find a user via his or her phone number and use that phone number to trigger the user's smartphone to display products purchased to save into their own virtual closet or send it to the virtual closet or archive system of previous purchases of the family member or friend. Reward system will trigger the first purchaser's phone number to trigger the first user's smartphone to capture, find, and display product details to the first purchaser.

All Marketing Objects from conditions satisfied from its source or company can be delivered public or private.

Viewership by synchronizing or linking the topic or subject matter you want. The system will search/identify topic and schedule it in your calendar.

Fashion Closet is a closet systematically set up for the user based on purchases. All purchases are archived and categorized. Clothing, shoes, beauty, jewelry product can make up the fashion closet.

System generated Recommendations can pull clothes from a user's fashion closet or an inventory of archived purchased products from each user and match it up with currently viewed products or products on sale from one of more vendor or retail stores at anytime and anywhere. These recommendation can come prior to a wedding, vacation, or any event that is schedule from the user or the system can just recommend products randomly based on newly stocked products, products that are discounted, previous purchases (purchase history), matching brands, etc. . . . user can also manually match up products. Product can be matched using the matching logic in the invention.

System can also just send the user system generated clothes and shoes (products) from wholesalers, vendor, or retail stores only.

Companies can use this system to dress mannequin inside the establishments or department stores.

Virtual closet and in-store and out of store recommendations:

Within the invention, any product that a user purchases is saved and categorized within the user's virtual closet or repository of archived purchases. All products details and attributes including the images are saved and categorized. Using Geo location technology, latitude and longitude coordinates, as soon as a user enters the store location, the system can immediate recognize the user via the digital computing device. The system may also recognize all the products details and attributes. The system may also via the online store may recognize products in the store that matches (color, sizes, and dimensions) the products previously purchased inside the user's virtual closet or virtual repository of archived purchases or previous purchases. The system will then collect one or more outfits (Top, Shirt, Pants, Skirt, Shorts, Shoes, Heels etc.) by grabbing the image and product detail within the user's virtual closet or virtual repository of archived purchases with products within the online store of the brick and mortar location via the matching logic and send the products to the user via the slide-by matching system, tri-slide, 9 flop or any other form in a form of a notification for the user to click on. Once the user clicks or access the notification by touch, the user's personal slide-by matching system, auto-match system, or tri-slide technology will appear or be accessed with all of the matching products from the store and virtual closet or repository of archived purchases. The user can now interchange those products recommended to them based off product within their virtual closet or repository of archived purchases via the matching logic, auto-match system, tri-slide or slide-by technology. The matching logic may also use a graphical database.

For Military Veterans within the invention: FIGS. 1-10

For those in the Military can request products and services through immediate directives or forecasted directives creating actions through voice command or manual input to deliver time sensitive results for when they need them. Whether these deliverables come from habits, likes, or from personal and business calendars, each action can be picked up from different advertisers, brands or other people on the system to pay for the product or service at need.

In another Example, the users can share on a gift card or rewards card adding money for a gift limit. Example: If the system knows the veterans birthday, their child's birthday, anniversary or any personal information for example, it can systematically initiate an action, directive or command and through multi-directional predictive analysis automatically issue a credit card, gift card or reward card and aggregate demand for other people on the system or the company or brands itself to add money to the gift card for the veteran to purchase a gift for his child for example. Companies can also send gifts. The system can automatically generate things that the child may like based on habits, likes, favorites through multi-directional predictive analysis or directives and display these products for the Veterans to view on the interface and then the veteran can choose the product he or she wants for their child. The users who want to provide for the veterans can be notified systematically about the veteran's needs or family members needs or personal or business special events by for example, veterans from their city or state, specific needs, specific special events, birthday months, specific stores, or on demand. All through Semantic and Artificial Intelligence.

In another example of multi-Directional Directives and Command memorization, if a company is looking for the perfect candidate for the perfect position or the Candidate is looking for the perfect career, FIG. 9 (the system through a digital process, digital resume or digital job description) the company can ask the system to notify them as soon as the resume that matches their job description is available or notify them as soon as the perfect candidate quits his or her job. And as soon as they quit, the system will automatically send them an email, request for interview, send information on the company, or automatically read their personally calendar, read the company's personal calendar, and schedule an interview time that meets both calendars availability. The user will have an indicator alerting the public that his or her resume is now open for hire or an indicator that notifies the public (companies) that he or she just resigned from their current position. Once the indicator is triggered, the resume of the candidate open for automatic synchronization or asynchronous or linking to the perfect Job description from many companies and placing them in ranking of the most compatible. The system can work vice versa, allowing candidates to find the perfect company. The directive is set, whether manually or by voice command, and system will wait on the condition to change or exist and perform an action(s) or multiple actions in accordance to the directive. If the directive or condition is available right away, then the system will deliver the results. This system also works the same if the candidate is trying to find the perfect Job Description or Career. As soon as the position is available, the candidate will be notified. The system is centralized.

SlideBuy Virtual Financial Assistant

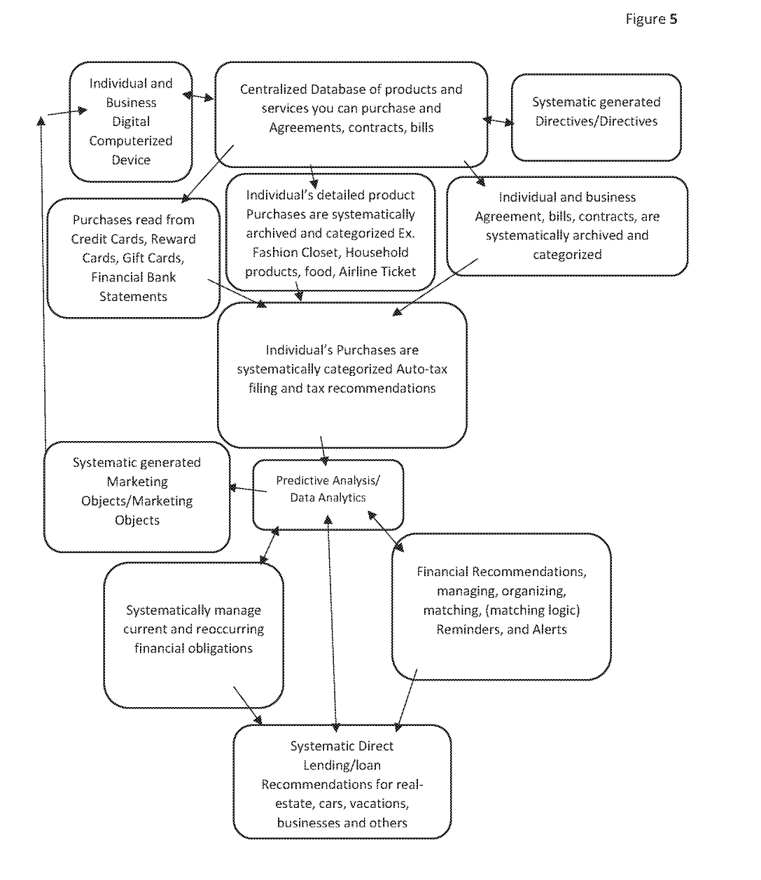

FIG. 5

Virtual Financial Assistant Summary

App and software program that uses predictive analysis technology by collecting financial information to help users plan and manage both short-term and long-term *financial goals and events; systematically file their income taxes, manage current financial obligation, bills, and make financial decisions/recommendations based on multiple financial inputs as well as future financial goals. *Financial Events=Retirement, Wedding, College, Vacation, Buying a Home etc.

Automatic Tax Filing and Tax Recommendation

Individual income taxes considering investment portfolio, buys, sells, trades, purchases relevant to tax credits, deductions and other itemizations. (i.e. medical, payments to student loans, books, property taxes etc.) and automatically tracks and send them to an electronic tax file throughout the year

Correctly categorize and file each purchase in real-time for each person in a online tax form or system and reconfigure each time for real-time tax gains, tax losses, tax liability, tax risk and much more.

At the end of the year the system will automatically piece all relevant tax information from file into a draft filing pending user approval/sign off, will electronically file both federal and state taxes for the user.

Validation will include a tax summary of potential filing scenarios highlighting the best financial recommendation from the assistant and why, but the user will have the option to override and pick to filing of their choice.

Programmed with tax laws and setup to automatically seek updates to laws periodically.

Produces the best possible financial filing for the users' individual unique filing situation which can include small business and managing investment portfolios.

### Example

Managing Current and Reoccurring Financial Obligations

Bill pay services that automatically read invoices/bill statements, agreements, contracts, to pay financial obligations automatically, reads pay statements to budget expenses

System will categorize which bills are to be paid first based on dates, priority due date, and priority. Time sensitive process. Manages the payment process for the user and recommends selection based on priority.

Connects to users other accounts for optimal financial recommendations such as credit cards, bank cards, investment accounts etc.

Designated email specifically for financial assistant that requires validation from the user (mitigating risk of spam and potential external fraud via hacking) in order pull through the email box that they technology will read, includes; mortgage bill, electric bill, credit card bills, and all other financial obligations that the user wants to include. Learns due dates and automatically reads statements and bills.

Categorizes all spending real-time so the user can get a snapshot at the click of a button to see financial pie chart of their concentration of spending at any given time. The system will highlight categories that have been overspent based on planned financial goals that have been previously identified.

### Example

Financial Recommendations, Reminders and Alerts

Evaluates credit card interest rates, outstanding balances, tax code/laws against purchases, payment priority (based on due date as well as type such as water etc) and tax bracket to make the best financial recommendation possible.

Collects information about users spending habits to make recommendations and send notifications (regarding electronic tax file)

Tax recommendations and/or notifications will trigger throughout the year as the user makes financial purchases that impact their taxes, tax bracket and/or filing status etc. such as; $ remaining to give to charity to maximize annual deduction.

Learns reoccurring financial obligations and alerts users to bills/charges that exceed expected thresholds or purchases and fall outside the user's typical spending habits, essentially and automatically reconciling purchases with bills and detecting errors in statements or potential fraudulent purchases and calculations. (Inaccurate month interest etc.)

Makes financial recommendations that align with long term and short term goals based on spending habits, for example, a planned vacation requires X saved per month for a future date, if spending habits begin to conflict with financial goals the assistant will alert and identify the behavior

### Example

IRA, Share bulk data, they can expand

Multi-directional between the Vendors, the users, and the financial institutions where they can all systematically share the necessary information necessary for their direct target market. Example is how system can match up clothes from stores to clothes from the closet of the user. Example: how price at store systematically drops for user that selects a condition change to be notified only when the product is 60% off.

Platform that Centralizes the Entire Financial Landscape

System through artificial intelligence, semantic intelligence, and machine learning will learn the underline detail agreements and contracts between the consumer and business or business and business for systematic managing, recommendations, reminding, organizing, coordinating, bill paying, payment options, investments, stock options, direct lending, data analytics and predictive analysis. For example, the system for each individual person can organize and manage what bills are a priority to get paid based on household or individual salary or income. System can recommend and provide input on pros and cons of particular bills that the individual or company chooses not to pay. The system could show the individual or business the total amount of interest of a particular bill that is not getting paid. The system can recommend between two different bills the individual or company is having a hard time deciding on which one should be paid first, which one can be put off for a month, or how long it will take to pay a bill etc. . . . . System will capture, archived, categorize, and save all bills, agreements, contracts, for individuals and companies (businesses) for but not limited to managing, matching, coordinating, bill payments, and bi-directional predictive analysis. Individual and company can select which bills, agreements, contracts can be added to their repository for artificial intelligence and machine learning. Reading and learning of these documents can be done through but not limited to email, scanning, Copy, paste, pdf, and word document. All sources can be interconnected.

System can also systematically tell a user if they need more charity donations or any kind of donation for a better income tax return. The system will always choose or recommend the best income tax return solution or the best possible outcome for the user. This systematic process will begin at the beginning of each year (January) and end the last day of January. The system will always keep the user in compliance for the best possible outcome. Each outcome can be reconfigured.

Different types of ways in our system directives are used:

First type of directive: Our system creates a demand for companies to reduce price to our demand, send Jay Z to Denver for a concert, let me know when the movie hunger games is on TV. The results of this demand can come from a single demand or an aggregation of demands all stemming from consumer directives. Companies can now send Marketing Objects

Second type of directive: our system can tell the system to let them know when the price of a product is reduced to the product they like, let them know when Jay Z is in concert in Denver, or let them know when Hunger Games is on TV. This is done by creating an algorithm to follow price changes from all products and calculating the reduced price from the original price and send out the marketing object to those who demanded to be notified at the percentage they requested or the new price point they requested, system crawl internal database for Mention of JayZ concert in Denver from Entertainment companies in our database, or system crawling for mention of the “Hunger Games” on TV from a particular network in our database or TV listings online. System can follow an Ecosystem of any type of product or service including a venue, restaurant, dealership, Entertainment options, hotels airlines, retailers, and the specifics of the categories or subject matter through demands of their choice even through voice command.

Anonymously companies in the invention can give price reductions to only those who created the demand on a marketing object, other than making it public. The rest of the public will get it at regular price, and these people will never know that it was on sale. In the bi-directional addition, the system can also initiate systematic Marketing Object distributions to the user.

Third type of directive: Remember system can also create a directive and tell the system when that directive exists, then here is another directive to do something else. For example: notify me when Jay Z is in concert, and when you first here about it, buy me tickets “based on a predetermined location”, and send the tickets and receipt to my email and update my calendar for that date with reminders leading up to that date.

Fourth type of directive: Directives can also be created from the system to make suggestions for products to buy, what shows to see, what concerts to see, what places to eat at, all based off predictive analysis, popularity of products, Birthdays, anniversaries dates of events, weather, travel, location etc. . . . .

The computer system may receive, via the computer network, a second directive, which includes second directive data with a second subject matter responsive to the first interest and a second time associated with the second subject matter. The computer system determines if the second directive includes second subject matter responsive to the first interest. The computer system enters the second directive data in at least one database on the computer system. The computer system then communicates the second directive data to the plurality of users via the computer network. The second directive data may include an assent, a conditional assent, or a counter-proposal.

The present invention can be embodied as devices, systems, methods, and/or computer program products. Accordingly, the present invention can be embodied in hardware and/or in software (including firmware, resident software, micro-code, etc.). Furthermore, the present invention can take the form of a computer program product on a computer-usable or computer-readable storage medium having computer-usable or computer-readable program code embodied in the medium for use by or in connection with an instruction execution system. In one embodiment, the present invention can be embodied as non-transitory computer-readable media. In the context of this document, a computer-usable or computer-readable medium can include, but is not limited to, any medium that can contain, store, communicate, propagate, or transport the program for use by or in connection with the instruction execution system, apparatus, or device

The computer-usable or computer-readable medium can be, but is not limited to, an electronic, magnetic, optical, electromagnetic, infrared, or semiconductor system, apparatus, device, or propagation medium.

A web crawler 720 systematically browses the World Wide Web for the purpose of populating the database 170 with system-generated marketing directives and/or marketing objects. Starting with a list of seed URLs, the Web crawler visits the URLs, identifies all the hyperlinks in the page and adds them to the list of URLs to visit. Such URLs are recursively visited according to a set of policies. The crawler copies and saves website information as it goes. Copied information may include photos, product descriptions, pricing information, and URLs for each product on-sale on a website visited by the crawler. This information may be used to create a system-generated marketing directive. The system may employ a metric of importance for prioritizing Web pages, by evaluating intrinsic quality and popularity in terms of links or visits. The importance of a page for the crawler can also be expressed as a function of the similarity of a page to a given query. Crawler process may also be created from semantic intelligence which translates and coverts human language to machine language.

Data may be supplied to the database through other sources. As an example, a data feed may be provided for the database to receive updated data from supplier (e.g., vendor and/or designer) data sources (e.g., databases). By way of example and not limitation, a CSV data feed may be used to load a CSV file to load product information from a supplier's database. The file may contain all data for all products from the supplier's database. Alternatively, the file may contain data for products that have changed since the last CSV file provided.

Data may also be supplied to the database through synchronization or asynchronous. One-way file synchronization, i.e., mirroring, may also be employed to update data copied into the database from a supplier's data sources. Consistency among data from a supplier's source to the target data storage may be established by timestamp synchronization. In this implementation, all changes to the source data are marked with timestamps. The time of all synchronizations are stored, at the source, at the target or at both locations. Synchronization proceeds by transferring all data with a timestamp later than the previous synchronization.

A supplier or business may also provide a portal (e.g., an enterprise information portal) (EIP), as a framework for making product information available, managing marketing directives, managing consumer directives and satisfying directives. An administrator of a system according to principles of the invention may access the supplier's data through the supplier's EIP. Additionally, a system according to principles of the invention may automatically access the supplier's data through the supplier's EIP, such as by using a crawler to systematically browse the portal to update indexes and data in the database.

All bi-directional directives and matching of all directives to the user, consumer, marketing object, subject matter, company, vendor, source or purchasing system can also be systematically generated, distributed, or satisfied using a graphical (Graph) database such as a AWS Neptune database.

All directives may be associated with a condition, financial deposit and expiration date when the consumer needs the directive to be satisfied. For example, a consumer can initiate a singular directive or a menu (plurality) of directives that are associated with the subject matter of interest from a search or a pictogram which can be system generated from the database or/and directly from the vendor or source that is carrying the product or service associated with the pictogram. The consumer can select one or multiple directives and select a condition and/or a financial deposit, and/or an expiration date when the directive needs to be satisfied. If the consumer searches for Justin Bieber, the search will deliver results of a pictogram of Justin Bieber. The pictogram of Justin Bieber may be associated with a menu of directives system generated from the pictogram that is associated with the subject matter of interest or from a marketing object where the menu of directives were manually or systematically inputted via portal from the source or company of the marketing object associated to the consumer directive. One of the directives may say “notify me when this Justin Bieber is on television”, one may say “notify me when this Justin Bieber is appearing in concert here”, one may say “create a demand for a Justin Bieber concert nearby and send it to an aggregation of his followers, and one may say “show me a demand by another follower who created a demand for Justin Bieber to appear in concert nearby. One directive can trigger another directive or action. For example, The directive that said “create a demand for a Justin Bieber concert nearby and send it to an aggregation of his followers” can trigger a directive or action or option that says “send this directive with a good faith deposit or deposit to increase the chances of the concert taking place”. It can also trigger a directive that says “I would only want to attend this Justin Bieber concert if we can attend the concert within the next 5 months”. A deposit associated with a directive for example could be a certain amount individually required by the system, the celebrity, promoter or the consumer via portal, to create a demand to be sent out to an aggregation of the celebrity's followers. The system, celebrity, promoter, or consumer can also have an accumulation of money collected as the deposit or trigger for the concert to take place or for the concert to be considered. All deposits may be held in an escrow account or bank account until the celebrity agrees to accept the deposit and/or agree to a concert date before that expiration date set by the consumer. If concert date expires or the celebrity Justin Bieber in this example declines the deposit money, then all money is returned back to the each consumer that participated in the aggregation. This reverses the process on how promoters get people to attend concerts. This process creates the demand first. Normally the concert is created and then the promoter goes out the get consumers to attend the concert through marketing. In this process, the demand is created first by an aggregation of followers, users or consumers in this case with a deposit from each user who wants to see a specific celebrity in concert, 200 k is collected as a deposit from the aggregation of followers or consumers, then the artist is notified. This can be done for every city and every state which in essence in creating the tour for each and every music artist in this example. This example and process can be applied to every subject matter or every pictogram associated with directives no matter the industry. The system can collect the aggregation of users who selected the same product, the same condition to be satisfied like a shirt and a condition of 50% off to be satisfied. If the user also selects he or she want to put down a deposit of $40 dollars to guarantee the product, then the system will search for all users or the aggregation of users who selected that they want that specific shirt and the they want it at 50% off with the minimum guarantee deposit of $40 dollars. Once the system, using Artificial Intelligence or a web crawler within the system gathers all users, the system via a web portal will notify the company or companies carrying the product for example and say we have 3000 users across the country that would like to buy this shirt if you can drop the price by 50% or a certain price point and we also have for example $30,000 dollars collected as a deposit waiting for you in an escrow. Do you want to make the deal? If the company accepts the offer, then the company will automatically send the promo code to discount the product to those users, but if they company decides not to accept the offer, then the money held in escrow will be returned back to the users. Via the company's portal within the system, all companies can select how many shirts they want allocated to receive for example the 15% off promo code, 30% off promo code, 50% off promo code and the response or distributions off the promo codes can be instant as the consumer directive is initiated from the user on which discount the user would like. The system will automatically know the number of discounts allocated for each product and the number of aggregated users wanting each selected discount. This process can be used for each subject matter selected and each consumer directive selected with a condition to be satisfied.

The system all works the same in different variations to all participants to receive system generated necessary information. All sources may be connected in a multi-directional process. For instance, one company's or consumer's directive, command, request, event, product, and/or condition change can trigger another company or consumer to initiate directives, commands or requests to another company or consumer. The creation of new directives and/or commands based on previously created directives and commands can be done simultaneously or instant.

Elastic Search technology can be used in the invention.

In this invention, sources, suppliers, business, company, user, vendor, merchant and agency may have the same meaning.

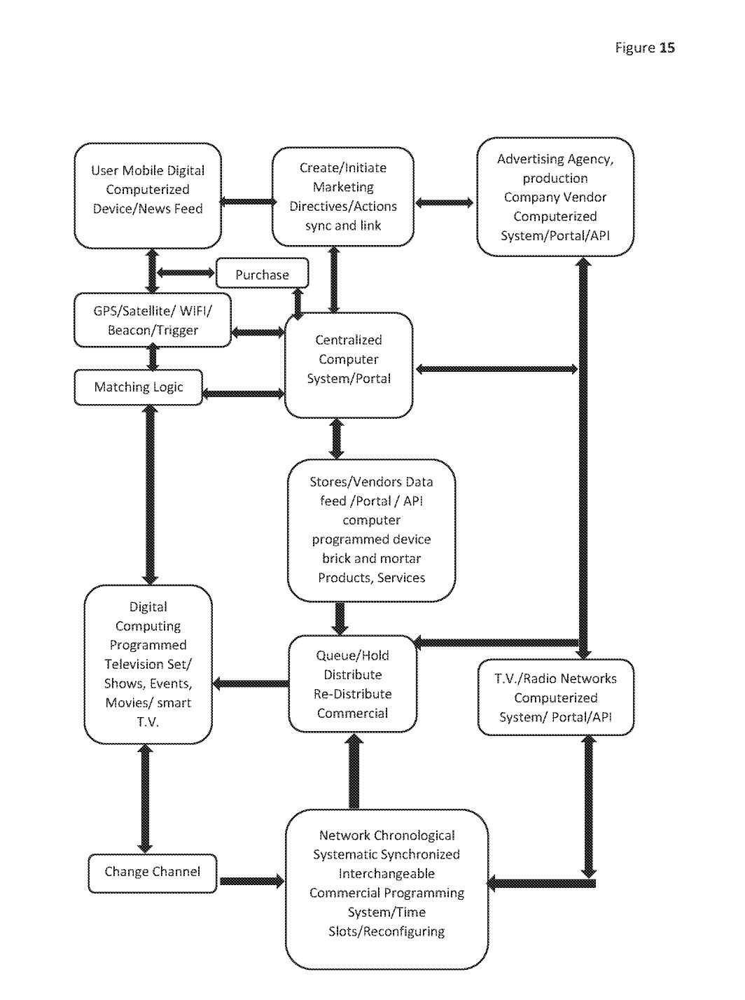

Personalized Commercials Via Television and Mobile Device (FIGS. 9 and 15)

Within the current invention, to provide personalized commercials to consumers, you will first need a centralized computer system of products and services connected to data feeds and portals from many companies, vendors, merchants or sources. The process can also be integrated using the products and services associated with websites or systems of any company, vendor, or agency.

Each product or service in the database will come with actions, questions, directives where any user can synchronized and link a product or service to themselves and a filters not limited to the time and date in which you would like to purchase the product or service. Within the time and date you are looking to purchase the product, the companies or vendors of those products and services can send you personalized commercials through your household television, mobile devices, or any television set that is located near the current location you are currently residing or where your personal mobile digital device is located.

For television sets, this is how it works:

If you have an household of five family members and each member synchronized and linked a product or a service to themselves for example the first member wants to know when BestBuy is having a 50% off sale on a 50″ Samsung T.V. set or needs any 50″ Samsung T.V. at a price point of $400 dollars from the original $800 dollar price tag within 30 days, and second member wants to be notified about Pop Concerts in the area, and the third member tells the system that she is having a “baby boy” that is due in 6 months and send a directive to notify her and send a matching marketing object when baby products are 60% off. Once these items, directives, and actions are selected, then they are linked to each family member or consumer. Each company, like advertising agencies, production companies, and radio, T.V. networks, through their portal or system linked to the system within the invention will also know instantly that this consumer only known by their unique ID number is looking to purchase or what they might be interested in. Advertising agencies and production companies in the meantime will be producing marketing videos for these advertising company's or companies worldwide to be sent to networks and companies such as Comcast. However, the process can also be done just using the individual networks without using companies such as Comcast. Advertising agencies, production companies, retail companies, or any company can buy commercials time slots locally or nationally on any network during shows, movies, sporting events, or news viewings.

These companies, the network like NBC, or our centralized computer system can now send personalized commercial to the household television sets. Each consumer's information is collected and sent to the company when the consumer sends a directive or sync and link a product or service therefore notifying the centralized computing system and the company their age and gender so each network, company, or our centralized computer system knows exactly what channel to deliver the personalized commercial. Commercials queued up distribution, will be sent to the channel the user or users are currently viewing and only during the 2 to 5 minute commercial time and if the user changes the channel, the system will hold the commercial in queue and distribute it to the next channel the user is watching. However, the system may show the commercial on the channel that the user just changed, if the changeover of channels occurs within a certain time period. It may be too late to stop the commercial, but the system may notice that the system never distributed the commercial when the user was viewing the previous channel, and save the commercial for the next commercial break on the next channel. This process can be repeated. Two or more commercials or videos, can be timely chronologically synchronized to fit the commercial time slot. This works perfectly with Comcast because their shows can be paused within a certain amount of time, therefore it doesn't matter if shows for multiple viewers finishes at different times. The number of commercials in queue for the each user who selected a marketing directive will come with a ticker that counts distributions as they go out, or place them on hold. Each ticker count may be linked to an accounting system for payments. For example, if you have a teenager in the household and they are watching a television show for teens on NBC, then send the commercial about any pop artist that may be coming to see a concert in the area they are currently residing and the exactly digital device whether mobile or a television set GPS location the consumer is located. If the user, travels to New York, then the company, centralized computer system or network can send the commercial to the users television set whether they are staying in a hotel room or watching television at a restaurant bar. The sync and link of products and services follows the consumer wherever they go using the location based GPS location of the consumer's digital mobile device. Consumer and consumer marketing directives can also be located to trigger nearby digital device (ex. television set) by a beacon when entering these physical locations. Depending what channel the consumer has the television set on and the age and gender, decides what commercial is being shown. If one television set is on in the household, then all personalized commercials can be shown. What is shown on television or what personalized commercials can be shown, can also be based on which consumer's digital mobile device is closer to the television set at home by proximity or GPS. This means a GPS trigger connected or integrated to the television set or digital mobile device will always ping each other or be set up to trigger when two or more devices are closer to each other.

When this trigger occurs, then it also triggers the synced and linked products of the consumer or family members and their devices, which then triggers the portal or system centralized computer within the invention, the company, and/or the network to deliver systematic personalize commercials to the consumers or household members. This process of triggers always happens when GPS location of consumer's digital device is in proximity of the location (company) of the product, service, or location of another digital device. Personalized commercials can always just go to their mobile digital devices. Personalized commercials can also be shown before music videos, movie trailers, movies, shows etc. . . . whether on television or any digital mobile device.

These television sets will be computer chipped, encrypted, and have triggers and GPS synchronization like smart phones and for companies to know what channels and shows and what time the users are watching. (Smart televisions) Personalized Commercials can always go to the consumer's digital devices after directives are associated with conditions. Commercials or videos can always be sent to the user's devices with the satisfied marketing directives or marketing objects are sent to the consumer. Televisions can also be linked to consumer personal phone number to complete the process within the invention.

This entire process is multi-directional and chronologically systematically synchronized to all devices, systems, directives, products and services of consumers and companies using predictive analysis for pin point timely product and commercial placement and commercial programming. Network programming system may be interchangeable. This means commercials and commercial time slots can change on the fly systematically or manually.

Networks will have a systematic system linked to the centralized computer system of the invention which are linked to company's videos or products and services also linked to the centralized computer system for systematic releases and distribution of commercials to the consumers or television sets nearby their digital devices or on their mobile digital devices based on triggers, sync and linked directives and actions on products, and GPS location. Commercials can be sent to the user's personalized news feed.

In another embodiment:

Since the television may be a smart T.V., each television may also be synchronized and linked to the consumers or user's smartphone for displaying or streaming commercials to the consumer via a television and radio at a time of the commercial time slots for each program. For example, if the consumer or user receives advertisement commercials to their smart phones or computer devices, those advertisement commercials may also be shown on the consumer's television set or a nearby television during the commercial break. Televisions may use a beacon technology, Bluetooth technology, GPS, WiFi, or any kind of technology to recognize if the consumer is near the television set. Recognizing is always constant when television is on. One television set, radio, or the computer within the television set, can be mapped to many different consumer's digital programmed computing devices, in essence turning any and each consumer's digital programmed computer device to that of its own. Signing them off once they are not nearby. Directives are stored in the database and accessed from a database. However, all and different commercial advertisement can be retrieved and stored in a queue for streaming. The television, radio or computer within the television may mix in its own marketing agency's commercials matching directives and subject matter of the first user for streaming with commercials coming directly from the marketing agencies, or commercials coming directly from the retail companies or brands themselves. Each company and network may push a commercial alone without using the networks like Comcast, CNN, FOX or marketing agencies etc. . . . , each company can stand alone. Television or radio computer programmed devices collecting users using nearby WIFI. Once the Smart T.V. recognizes who is in proximity of the television, it will search for those consumer's marketing directives to determine what commercials and how many commercial to stream or play as a video.

For mobile smart phones, mobile digital devices:

The entire process of distributing personalized commercials to consumers or user or companies can also be done using scrolling chronological synchronized news feeds. These news feeds very similar to Facebook, Instagram, Snapchat can all receive personalized commercials directly from any company, advertising agencies, or production companies or individuals by creating or initiating marketing directives or selecting actions with or with time-sensitive conditions, conditionally or unconditionally. Any created, initiated or selected marketing directive can be associated or trigger a commercial to be distributed to the consumer or user who created, initiated, or selected the marketing directive. Marketing directives can come with time sensitive dates when a marketing object needs to be received. Commercials associated with the product, service, or marketing directive can be sent to the consumers or user's news feed or calendar within the mobile digital device (ex. Smart phone). Commercials or videos, advertising associated with the product, services, topic, or information created, initiated, or selected as a marketing directive by any user, can be distributed to that user in real-time or soon as practical. Directives are linked to products and services of any company, agency, or vendor's website or system. Payment from the any company may be paid out with each matching commercial distribution to the user's directive.

Each consumer's information (unique Id, age etc.) is collected for data purposes and sent to the company when the consumer creates, initiates, selects a marketing directive or sync and link a product or service therefore notifying the system and the company their age and gender so each advertising agency, production company, or our centralized computer system knows exactly what user to deliver the personalized commercial to. Commercials queued up distribution, will be sent to the calendar, digital device, and news feed of the user or users who have recently sent out a marketing directive. Systematic distributions! Each marketing directive may trigger a different commercial for distribution. All users who select the same interest or marketing directive, may get delivered the same video commercial or ad.

If a user initiates, selects, creates or triggers a marketing directive or synchronized and linked a product or a service to themselves wanting to know if BestBuy is having a 50% off sale on a 50″ Samsung T.V. set or needs any 50″ Samsung T.V. at a price point of $400 dollars from the original $800 dollar price tag within 30 days, and wants to be notified about Pop Concerts in the area, and tells the system that she is having a “baby boy” that is due in 6 months and send a directive to notify her and send a matching marketing object when baby products are 60% off. Once these items, directives, and actions are selected, then they are linked to the user and any advertising agency, marketing company, or any company advertising videos or materials associated with these products or services will be systematically distributed to the user. Commercials or material are distributed when the marketing directive of the user matches the marketing object of the company/business. The user gets advertising commercials associated to exactly what they want or is looking to buy.

The centralized computing system will have a multi-directional systematic distribution system.

This entire process is multi-directional and chronologically systematically synchronized to all devices, systems, directives, products and services of consumers and companies using predictive analysis for pin point timely product and commercial placement and commercial programming.

To solve one or more of the problems set forth above, in an exemplary implementation of the invention, a consumer-driven centralized marketing system includes a centralized processing engine, a directive repository and a marketing object repository. Participating users may submit directives to the processing engine. Each directive comprises an authoritative instruction pertaining to delivery of electronically deliverable marketing object. A directive may be a consumer directive or a marketing directive. A consumer directive may be one of many different types including, a location directive, a personal information directive, a general directive and a specific directive. A personal information directive may provide a user's gender, race, age, income level, profession, and personal interests to facilitate delivery of marketing objects pertaining thereto. A general directive remains active until canceled. A specific directive and marketing directive instructs the system to which consumers the system should send a particular marketing object. The centralized processing engine saves each received directive as a record in a database referred to as a directive repository. A marketing object may be provided by the user or a third party. A marketing object may comprise any of a wide variety of marketing items, such as coupons, announcements, advertisements, promotional codes, job postings, resumes, personal profiles, etc. . . . . The centralized processing engine may save each received marketing object as a record in a database. In the case of a marketing object provided by a user, a marketing directive provided by that user for the marketing object may specify to whom and when the marketing object may be distributed via the system. A consumer directive instructs the system to deliver certain types of marketing objects to the user via the system.

All directives and marketing objects may come with a condition like a date and time for the user to receive the matching marketing object and a company to distribute a marketing object.

Any directive or marketing object can be associated with a condition. A directive can be associated with a marketing object vice versa.

The notification is generated when a specified condition is satisfied. Conditions and notifications vary according to the subject matter. By way of example, a user may be notified when a product becomes available, is on sale (i.e., at a discount, time and date to receive product), or is offered by a vendor at or below a certain price, or is available as a refurbished or open-box item. A user may be notified when a vendor introduces a new product or a newer version or the next generation of a product. A user may be notified when tickets to an event are offered for sale. A user may be notified when a celebrity makes an appearance locally or on television, or is interviewed, or appears in a newly released movie, or makes a public announcement. A user may be notified of each show or movie at a particular venue. These are non-limiting examples of conditions and notifications.

A user may specify a condition for notification using a user interface with form fields. The fields vary according to the subject matter to which the notification pertains. In the case of a product, fields may include a selling price below which a user is willing to purchase the product, availability at a specified venue, coupons, public announcements, and other variables pertaining to the marketing and sale of a product. In the case of a celebrity, the conditions for which notifications may be provided may include television appearances, in-person appearances, shows, announcements and the like.

A user's calendar may be updated with a notification. This is especially useful for time constrained notifications, such as notifications of conditions that will exist for a limited time (e.g., sales, live performances, coupons with expiration dates). Illustratively, an .ics iCalendar file or other compatible calendar file or data stream may be sent (e.g. pushed) to a user's calendar app on the user's client computing device to populate the local calendar with the date-related and/or time-related notification information. The process may be automated, requiring no user intervention.

First user marketing directive associated with a subject matter and condition matching the second user consumer directive and subject matter associated with a marketing object when satisfied, then distributed with a link to facilitate a purchase to the first user

First user marketing directive associated with a subject matter and a condition searching for the second user matching consumer directive and marketing object in the meantime sending the first user commercial advertisement associated to the matching subject matter prior to the matching marketing object distribution associated with a link to the first user to facilitate a purchase.

The marketing object is an image, file, stream or data that will be forwarded to each user with a consumer directive that matches a marketing directive. The marketing object may be stored in the database

A computer implemented consumer-driven centralized marketing methodology comprising steps of: receiving from a first user via a first programmed computing device a first directive, said first directive including a condition and identifying the first user and identifying a subject matter of interest to the first user, the condition comprising a condition from the group consisting of a price condition for the subject matter of interest, a pricing discount for the subject matter of interest, a topic for the subject matter of interest;

Storing the first directive in a database on a second programmed computing device at a first time;

Receiving from a second user via a third programmed computing device a marketing directive, said marketing directive identifying a marketed subject matter and including a marketing object;

Storing the marketing directive in the database on the second programmed computing device at a time other than the first time;

Subsequently, using the second programmed computing device, determining if the subject matter of interest of the first directive matches the marketing directive and subject matter and if the condition is satisfied, in the meantime sending the first user commercial advertisement associated to the matching subject matter prior to the copy of the matching marketing object distribution associated with a link to the first user to facilitate a purchase of the marketing object;

If the subject matter of interest of the first directive matches the marketing subject matter and the marketing directive and the condition is satisfied, then making available to the first user, via network communication, from the second programmed computing device to the first programmed computing device, a copy of the marketing object associated with a link to facilitate a purchase of the marketing object.

Time bound provisioning is available. All directives may be time bound. In other words, a directive may be active for a limited period of time, defined in hours, days, weeks, months or years. For example, a general directive may be time bound for a year. The user associated with the general directive may receive a reminder of the time limit prior to the expiration, giving the user a chance to re-provision or remove the time limit. As another example, a merchant user may impose a time limit on a marketing directive for a coupon. The marketing directive may expire on a determined date.

Unit provisioning is also available. For example, a merchant may want to limit a marketing directive to a maximum of 100 or 1000 or 100000 users or transactions. In this case, after the unit limit is reached, the marketing directive expires. The unit limit is reached when the number of copies made available to users equals the unit limit or when the number of transactions using the marketing directive (e.g., using a coupon provided with the marketing directive) exceeds a unit (e.g., transactional) limit. For fairness, in one implementation, the limited number of users may be determined randomly, or using a random selection algorithm, from all users with consumer directives to which the marketing directive is responsive. Alternatively, the limited number of users may be selected based on seniority of their consumer directives—first posted, first served. These and other user selection criteria may be employed if a unit limit must be applied. In the case of a transactional unit limit, the limit may be applied on a first come first served basis.

Buying Products in Real-Time from Television or Radio

Actions or directives can also be selected to interact with television to receive information from a particular product or service to buy from a phone instantly. Celebrities, promoters, designers, television networks, television shows (e.g., QVC) radio networks may use such functionality to promote their shows and the products featured in their shows. A user may be notified of the date and time that a televised or radio broadcasted event, performance or appearance is occurring, or a product is being displayed on TV or discussed on radio. The notification may include a calendar entry. Concomitantly, the system may include a list, for each show or program, of products that appear in the show or program by time and date. The list may be linked to the notification and calendar entry provided to the user. A television show's calendar may synchronize with the user's calendar on their phone in real-time or the system. When an action or directive is selected the product shown in real-time will have a control or options for the user to select in real-time on their phone displaying the product on one or more strips in order to make a purchase.

Network or television programming and retailer's product details via data feeds, API, can be synchronized with the system within the invention and with the user's mobile digital device, remote etc even if coming from a satellite . . . . This synchronization can come with a trigger for the user to initiate for displaying products shown on television or heard on radio stations into their mobile digital devices, data feeds or calendars at the same time they are watching the television or listening to the radio. Each network, celebrity, personal stylist, designer, retailer or any source will have a portal which has access to the repository of archived purchases or universal virtual closet for selecting items or products they want users to access for product details while they are on television or at events. Any source may select any item within the virtual household for wearing purposes or select something from the repository of archived purchases or household they want to display on others phones or digital device when those users or viewers trigger the show at the time the product is shown from synchronization or the time or timeframe the Fashion Advertising Model is saying they are wearing the products or items. For example, if a specific celebrity like Justin Bieber selects products from his virtual closet he is wearing today at 7 am and then selects the network and/or show he is wearing those products on, then anyone who inquiries about Justin Bieber, can know exactly what he is wearing on that show at that particular time and day. The celebrity (Fashion Advertising Model), just like any other source or Fashion Advertising Model will have a portal or Page that lets them select the products they are wearing today and the network, show, or event they are wearing it on or the location they are wearing it at, and the day and time they are wearing the products. Most celebrity location awareness will be determined by the calendar of the event the celebrity will be appearing. The chronological synchronized programming of the networks or television programs may be synced with user's mobile digital devices. User's may be alerted, prompt, or notified on products or services associated with marketing or consumer directives during or prior to commercials coming on television or the radio for viewing or purchasing purposes. Companies, advertising agencies, or any company may have their products or services shown on a television show, movies, news, and commercial synchronized networks programming time slots 24/7 and their data feeds or portals to these products and services in the centralized computing system of all things. Once a television show or radio commercial, event, or product is triggered, a list can appear with images showing products on that particular program, show, or movie for the user to select. These images and product details will also trigger the data feed or portal or website matching the products that particular hour or time shown with the products or services within the centralized computer system or repository. The process is chronological synchronized between all devices, all consumers, network programming systems, data feeds, and portals. The networks may also issue a data feed to companies for product syncing with their programming. Companies or networks during producing or prior to airing of the shows, events, news, or movies may have their own portal and website where they could list products they purchased from another storefront or the centralized repository within the invention. Within the centralized repository of products from multiple data feeds from various companies, the producers, directors or Production Companies of the shows or networks can access the website or application to purchase products they will be using in the production of their show, programming event, news event, or movie. Once the products are purchased, these products will be categorized, archived or save within their inventory within their own web site of purchased products. Once the products are categorized, any company, network, producer, director, or production company can access or select any product they will be using on their show, event, news, or movie before or during production or filming, and/or they could select products that will be shown during programming prior to the program being aired on television or radio. Each company, production company or producer or director will have to sign up for an account to the centralized system and repository of products as described in the invention.

Within the production companies, networks, producers, or director's account or website, they will have a matching interactive synchronized chronological calendar of programs being aired, to that of the television or radio networks calendar of programs being aired. The purpose of this is so these producers, directors, or Production Company, or networks could match up the products being displayed on the particular show and sync it with the time and date the actual show, movie, or event will be shown or aired. Once again, all consumers will have a trigger to sync to the program to display the products they are viewing, inquiring, or want to purchase. Each product displayed comes with product detail information, a price, and where it can be purchased. Products can display by selecting the show anytime or during the time shown or trigger of the mobile digital device syncing with the television set or radio station.

In this invention, commercials, shows, movies, events, and news are equal to or the same as video, video data, video streaming when delivering or distributing advertising, content, products or services to the user, customer, or consumer.

Universal Virtual Closet is the area of focus for claims with many ways on how it's used: (uses matching logic and Slide-by Technology)

Virtual Closet and Repository of Archived Previous Purchases

System's virtual closet and other features can integrate with the websites, rewards system, check out systems, or point of sales systems of vendors and other companies. For example: If a user purchased a product from a vendor's website or stores or within the centralized system within the invention, the product that was purchased can be sent as an image and product details to the user who bought the product or to the person's virtual closet who the user wants the purchased product to populate and categorize. User will have option “button” for the product purchased to categorize into their own virtual closet or archived purchases or a friends or family's virtual closet or archived purchases by prompting the contact list of friends and push a button that allows that product purchase to go to the friend's or contact's virtual closet or repository of archived purchases. The button will also come with a snooze button that tells the system to delay the message, push the product(s) to their friends or family member's own virtual closet or repository of archived purchases and options to give the distribution or notification of the product purchased at least for example 5, 10, 20, 30 days before alerting the friend or family member about the product. Then the user who For example, If the user is buying a product for his girlfriend's birthday a month from now, the user will have the option to delay the response for 30 days that will ask his girlfriend if she would allow this product to be categorized in her own virtual closet. The girlfriend or recipient will have a button “accept” that allows her to accept or reject. (prompting message sent with product) user's product or service info may be categorized in the financial system or tax organizing system within the invention for correct and accurate categorization.

Product information, images can also be captured by credit card, merchants services, gift cards, reward cards, rewards system, coupons to be categorized to the user's Virtual closet or archive purchases within the invention.

Our system can also be linked to the company's reward system or point of sales. The reward system can find a user via his or her phone number and use that phone number to trigger the user's smartphone to display products purchased to save into their own virtual closet or send it to the virtual closet or archive system of previous purchases of the family member or friend. Reward system will trigger the first purchaser's phone number to trigger the first user's smartphone to capture, find, and display product details to the first purchaser.

Fashion Closet is a closet systematically set up for the user based on purchases. All purchases are archived and categorized. Clothing, shoes, beauty, jewelry product can make up the fashion closet.

Universal Repository of archived previous purchases or virtual closet: The virtual closet or archived system for previous purchased products can all be universal. This system can work across all stores. Once a user makes a purchase at the point of sale device, the system can recognize the user via payment system, rewards system, reward card, phone number, visa, mastercard, Samsung pay, apple pay, american express etc and the products they purchased. Purchases made from a credit card can trigger the digital device or smartphone of the purchaser, find the image and product details of the product purchased in the specific brick and mortar department store for example or online store for example in our database and send it and display it to the user's digital device or smartphone in a list or queue. The system then gives the user the opportunity to save those products in its own virtual closet or send them to a family member or friend in which the purchased product was intended for so they can accept or reject it from their own virtual closet. Credit card or payment system can be linked to the bank and can send a notification to the user, which then sends trigger to the user's smartphone to display products.

Each user will have the opportunity to take a selfie or take a picture to showcase everything that they said they were wearing that particular time duration or times, morning, day or evening when they select each product they are wearing from their virtual closet. System will capture product details image including and save it to the database. In another example, the mannequin system can be used with the entirety of the invention for a user to shop for family member's or friend's exact sizes of clothes or any other product and tell the system or through an action via the digital device to send it to the family member's or friend's personal virtual closet or archived purchases once the product is purchased by the first user. Once the product is sent, the user has the opportunity to accept or reject. If the family or friend accepts, the product will be automatically categorized into their own virtual closet or archive system for all purchases.

Also, when someone makes a purchase at the stores physical location, please tie what is purchased using the stores reward system (phone number of customer) which is linked to our system to recognize customer and products purchased (via product code) to add products purchased to their virtual closet. once the phone number is entered and the product code is scanned, the system will recognize the product detail online within the invention and give the customer the option to add the product(s) to his or her own virtual closet or repository of archived previous purchases or send them to a family or friend who is captured in the mannequin system.

Virtual closet and in-store and out of store recommendations:

Within the invention, any product that a user purchases is saved and categorized within the user's virtual closet or repository of archived purchases. All products details and attributes including the images are saved and categorized. Using Geo location technology, latitude and longitude coordinates, as soon as a user enters the store location, the system can immediate recognize the user via the digital computing device. The system may also recognize all the products details and attributes. The system may also via the online store may recognize products in the store that matches (color, sizes, and dimensions) the products previously purchased inside the user's virtual closet or virtual repository of archived purchases or previous purchases. The system will then collect one or more outfits (Top, Shirt, Pants, Skirt, Shorts, Shoes, Heels etc.) by grabbing the image and product detail within the user's virtual closet or virtual repository of archived purchases with products within the online store of the brick and mortar location via the matching logic and send the products to the user via the slide-by matching system, tri-slide, 9 flop or any other form in a form of a notification for the user to click on. Once the user clicks or access the notification by touch, the user's personal slide-by matching system, auto-match system, or tri-slide technology will appear or be accessed with all of the matching products from the store and virtual closet or repository of archived purchases. The user can now interchange those products recommended to them based off product within their virtual closet or repository of archived purchases via the matching logic, auto-match system, tri-slide or slide-by technology. The matching logic may also use a graphical database.

Virtual Closet (Follower interchanging products from their own virtual closet) News feed:

The Virtual Closet can also be used when a follower finds a Fashion Advertising Model (some who wears their clothes previously purchased from the centralized system of products) from a news feed (like Instagram and Facebook), the system can recognized those products worn for the follower and send them to the Follower's Slide-by matching technology. Once the product worn from the Fashion advertising Model are in the Slide-by matching technology of the follower, then the follower can access his or her own closet to see the products worn by the Fashion Model matches or looks side by side with products from his or her own virtual closet. This technology works because the Fashion Model always takes a picture of themselves before posting and the Fashion Model selected what they were wearing when they posted the picture on the news feed of the social media. The system will then recognize it for the follower.

Mannequin System

Mannequin system will save clothing or shoe sizes, favorite fashion styles, birthdays, anniversaries, height, weight, or any other personal information for the user and any of their friends and family and integrate with the entirety of the existing invention. In one example, the Mannequin system can allow a user to search for pair of jeans or shirt in their exact size and tell the system to find every person in the system with their exact weight, height, pants size or any other dimensions that has taken a picture wearing those exact same jeans. This will give the user an opportunity to see what those specific pair of pants in this example looks like on another user with their exact same body dimensions.

Recommendations for events purchased through the system:

System can recognize each event and how people dress at the event to recommend products to wear for the user.

System generated Recommendations can pull clothes from a user's fashion closet or an inventory of archived purchased products from each user and match it up with currently viewed products or products on sale from one of more vendor or retail stores at anytime and anywhere. These recommendation can come prior to a wedding, vacation, or any event that is schedule from the user or the system can just recommend products randomly based on newly stocked products, products that are discounted, previous purchases (purchase history), matching brands, etc. . . . user can also manually match up products. Product can be matched using the matching logic in the invention.

System can also just send the user system generated clothes and shoes (products) from wholesalers, vendor, or retail stores only.

Companies can use this system to dress mannequin inside the establishments or department stores

Artificial Intelligence recommends products based off Flight info purchased from system, weather etc. . . . system can basically pack your suitcase from a collection of scheduled events.

System captures and saves products and services from the centralized system and repository of a family of vendors and file them into categories for the user. Example: if the user purchases a shirt, pants, bike, airline ticket, concert ticket and hammer, the system will save images, product and service details and file it away in the user's personal virtual closet, tax filing, and financial planner and just the category for which it belongs for tax purposes, financial recommendations, financial advising, matching purposes, recognizing saving or spending habits amongst a unlimited of other things. Features will be a part of artificial and semantic intelligence and machine learning with the current invention. All features can be systematic and automatic with or without user intervention. Our vision is to create a centralized world where business marketing and consumer's needs and wants not limited to products, services, and entertainment options from all industries will be learned and managed for timely pin point systematic recommendations, reminders, and purchases based on priority and popularity with little or no user intervention. The assistance of such a system will significantly reduce marketing cost of businesses while significantly increasing B2C and C2B awareness of timely mutual interaction.

System can periodically read calendars of the user to look up Flight info to determine the city, state, and country the user has scheduled a flight. System will also determine the location of the hotel the user will be staying. System determining flight information and hotel information from user can also be read without reading the calendar. Since the user will be purchasing airline tickets and hotel stay from a centralized system of all products and services from multiple industries, the system will record information of these purchases to determine where the user is going or staying. System can also record information, dates and times of other purchases for that particular day or any particular day to determine everything that user will be doing. For example: the user may purchase a concert ticket in advance, make reservations for a restaurant, go to a night club, Wedding, etc. . . . . Depending where the user is going, what tickets they purchase on those days through the system, night club they may be going to, the system will perform predictive analysis and recommendations to send options of clothes the user might want to purchase on that trip. For example: Las Vegas, the system could send different bikini or swimwear if the trip was determined to be in the summer time. The system can also send matching outfits, shoes etc. . . . to the user to match up clothes or shoes they previously purchased from the Slidebuy system that was in their virtual closet with other clothes from one or more merchants or retail stores. The system could also just systematically select outfits for the user directly from their closet. The system could send movies the user might like for their flight to Las Vegas during the boredom gap from the flight time of the trip. All without the intervention of the user which includes the consumer and the company or source. System can also know where the user is traveling, determine weather, and then start recommending clothes to wear during the duration of the trip. Basically packing the user's suitcase based on known intelligence within the system. For example, events purchased and scheduled within the centralized system, weather etc. . . . . The system will know the route they might be traveling to get to their hotel to notify them of things that are interesting to them or they need to do along the route based off directives the user selects or voice commands. System generated recommendations and predictive analysis based off purchases, calendar info, schedules. AI and machine learning. Recommendations, reminders can be based off any topic, information, industry, product and services from the centralized system.

System or platform can use inventory information and data feed to promote or market products and services automatically to consumers without user intervention. If the company has an overstock of any product or have a product that has not sold after a certain period of time for example 60 days, system can be set through triggers to set out product details to the right target market who issued a directive to get that product at the condition they requested. If the company set in our system or theirs to automatically discount one or more products a certain percentage after 60 days, the system could systematically distribute these products or services to the correct target market based on if the user(s) chooses a system generated directive or action to be notified when a product or service drops a certain price point, or when an directive or action of the product or service conditions changes to satisfy the user, or when the condition requested by the user change is private or public knowledge within a certain time or for the very first time, or if the condition of the product requested already exist. For example, if a user chooses to select or create a directive or action to be notified when a specific shirt price point drop at a certain price, if that product from that specific retail company that has that specific shirt in their inventory or any company that has that shirt in their inventory selects to systematically have filters or triggers set to drop the price a certain percentage based on an aggregation or singular demand to have that price dropped to a certain percentage by the user(s) or based on expiration date and trigger date to automatically have that product or service price dropped, the system or platform will systematically send the notification to the user(s) who have selected the action or created the directive to be notified. The system or platform will systematically schedule events like concerts, comedies, movies tickets, or any entertainment options in the user's calendar and can purchase these items at the same time. User's credit card information will be saved in the system for purchases. User chooses directive to have system automatically purchase product or service on demand or when it's first available for purchase.

System can also send the product that is reduced in price or in stock to the user's auto-matching Slot Machine Mode feature or product reels with the correct product size and color for product matching recommendations from the centralized repository of vendors or from the user's virtual closet or any other product categorized for the user.

Knowing what a Fashion advertising Model (any person who wears their own clothes for pay) is wearing in real-time based on triggers at the current location and match up products seen with products in the “followers” virtual closet:

Consumer-Based Advertiser (Fashion Advertising Model) FIGS. 1-5, 6,10, 11

When matching products from the consumer-based advertiser feature, the advertiser can match up products from their closet. The user can sync or ping a consumer-based advertiser in real-time to see what they are wearing from multiple categories and compare or match the products worn by the consumer-based advertiser to products saved in their archive of purchased products or personal fashion closet. User can also compare or match products shown on Television or worn by celebrities to their own in their personal Virtual fashion closet or archive of purchased products or services.

Consumer-based advertiser or Fashion Advertising Model: within the invention, if the user trigger, ping, activate or sync an area to find out information on a specific product or products that the consumer-based advertiser is wearing or if the person they are inquiring about is advertising products for the system . . . the Sync or activate button will trigger the GPS location of the user. It will then trigger the phones or devices of anyone in that specific location or a specific radius of the user or follower or trigger person and display all profiles and products selected to be worn by the Fashion Advertising Model from the virtual closet that specific day and time. If any Consumer-based Advertisers are found within that specific location, the system will them capture the products worn and entire profile of the consumer-based advertisers or fashion models and display it on the screen for availability of the user that pinged, synced or inquired about the consumer-based advertisers products that were worn on that day. If the user inquiring wants to follow the consumer-based advertiser or fashion model for future awareness of products worn, details of those products, pricing, or store info in the future, they can then friend the consumer-based advertiser. Consumer-base advertiser gives permission to any user to inquire or follow products they wear via system.

User can also trigger, activate or sync the location they are currently inside and receive product information for matching purposes or system generated recommendation, pricing, or matching purposes from their own personal archived purchased products or fashion closet. The trigger can also be systematic and products can be recommended based on location, GPS etc. . . . .

A consumer-based advertiser is a human fashion advertising model that advertises products they purchased from the retail store, designers, or vendors to earn money or commission by wearing the products.

Any users (follower) can save styles as favorites and the user could have the system display the styles in there News feed all the consumers advertisers in the network who are wearing their favorite style to see different looks and the user could also see different products for sale of their favorite style. Users could take a picture of outfit and user could save picture of them wearing it. Each product in the picture can be added to the slide-by or 9 flop for interactive matching.

Any product worn in picture can still be purchased separately. Our system can place them all in Slide-by, auto-match, 9 flop, or cart for viewing and purchasing.

9 flop uses a 9 window auto-match technology with similar matching logic technology as the slide-by with or without the borders. Products in each window can flip-flop before stopping and adding the matching product or use any other variation of displaying. Reference FIGS. 1-6 and FIGS. 9 and 10,11)

Knowing product information from any location in real-time: FIGS. 1-4,6,10,11 In addition to a Consumer advertiser, the user can find out the price of anything is real-time by initiate a trigger that will pull up objects at the single location based off the GPS location. Companies or sources will have categories of purchases archived and can use those products for displaying at a location of their choice. This is done by portal or website. Whenever, someone or a user is in the location, the user can trigger products for purchase in that particular location to display on their screen, mobile phone, or device. User will have portal and fashion virtual closet or a system that archives all purchases to categorize it or organize it in the correct area within the household and display products and match up products via the slide-by technology. Also you can know about the other locations that you are not currently. Locations can be in or outside.

Trigger the location: When a user triggers his location by using a trigger button on the digital computing device, the GPS location of the user will be activated. The GPS location will form a specific radius, for example 50 feet or 100 feet and trigger anyone or in this case any digital computing device that is located within the radius at the time of the initial trigger that also is a part of the universal centralized system within the invention or that is also a part of the universal virtual closet or universal system of archived purchases. Once the other computing devices are triggered, the system will access the products the Fashion Model selected he or she were wearing the particular time and day and the profile of that Fashion model, and then the system will display the products worn onto the followers digital computing device at the triggering event. The products selected at the time and day the user selects them, will exist or display to the follower or other user's digital device during trigger until another time or day is selected or until the user selects another product or outfit, or until the user select a “Stop wearing clothes” button for example. The Displayed products will be shown as a selfie and/or a picture and/or products displayed in a random or specific order or products shown into the slide-by auto-matching system. Fashion model will have a button to opt-in when they are ready to share products they are wearing to other users who triggers their location or to other users who wants to know what they are wearing.

Buying Products in Real-Time from Television or Radio

Actions or directives can also be selected to interact with television to receive information from a particular product or service to buy from a phone instantly. Celebrities, promoters, designers, television networks, television shows (e.g., QVC) radio networks may use such functionality to promote their shows and the products featured in their shows. A user may be notified of the date and time that a televised or radio broadcasted event, performance or appearance is occurring, or a product is being displayed on TV or discussed on radio. The notification may include a calendar entry. Concomitantly, the system may include a list, for each show or program, of products that appear in the show or program by time and date. The list may be linked to the notification and calendar entry provided to the user. A television show's calendar may synchronize with the user's calendar on their phone in real-time or the system. When an action or directive is selected the product shown in real-time will have a control or options for the user to select in real-time on their phone displaying the product on one or more strips in order to make a purchase.

Network or television programming and retailer's product details via data feeds, API, can be synchronized with the system within the invention and with the user's mobile digital device, remote etc even if coming from a satellite . . . . This synchronization can come with a trigger for the user to initiate for displaying products shown on television or heard on radio stations into their mobile digital devices, data feeds or calendars at the same time they are watching the television or listening to the radio. Each network, celebrity, personal stylist, designer, retailer or any source will have a portal which has access to the repository of archived purchases or universal virtual closet for selecting items or products they want users to access for product details while they are on television or at events. Any source may select any item within the virtual household for wearing purposes or select something from the repository of archived purchases or household they want to display on others phones or digital device when those users or viewers trigger the show at the time the product is shown from synchronization or the time or timeframe the Fashion Advertising Model is saying they are wearing the products or items. For example, if a specific celebrity like Justin Bieber selects products from his virtual closet he is wearing today at 7 am and then selects the network and/or show he is wearing those products on, then anyone who inquiries about Justin Bieber, can know exactly what he is wearing on that show at that particular time and day. The celebrity (Fashion Advertising Model), just like any other source or Fashion Advertising Model will have a portal or Page that lets them select the products they are wearing today and the network, show, or event they are wearing it on or the location they are wearing it at, and the day and time they are wearing the products. Most celebrity location awareness will be determined by the calendar of the event the celebrity will be appearing. The chronological synchronized programming of the networks or television programs may be synced with user's mobile digital devices. User's may be alerted, prompt, or notified on products or services associated with marketing or consumer directives during or prior to commercials coming on television or the radio for viewing or purchasing purposes. Companies, advertising agencies, or any company may have their products or services shown on a television show, movies, news, and commercial synchronized networks programming time slots 24/7 and their data feeds or portals to these products and services in the centralized computing system of all things. Once a television show or radio commercial, event, or product is triggered, a list can appear with images showing products on that particular program, show, or movie for the user to select. These images and product details will also trigger the data feed or portal or website matching the products that particular hour or time shown with the products or services within the centralized computer system or repository. The process is chronological synchronized between all devices, all consumers, network programming systems, data feeds, and portals. The networks may also issue a data feed to companies for product syncing with their programming. Companies or networks during producing or prior to airing of the shows, events, news, or movies may have their own portal and website where they could list products they purchased from another storefront or the centralized repository within the invention. Within the centralized repository of products from multiple data feeds from various companies, the producers, directors or Production Companies of the shows or networks can access the website or application to purchase products they will be using in the production of their show, programming event, news event, or movie. Once the products are purchased, these products will be categorized, archived or save within their inventory within their own web site of purchased products. Once the products are categorized, any company, network, producer, director, or production company can access or select any product they will be using on their show, event, news, or movie before or during production or filming, and/or they could select products that will be shown during programming prior to the program being aired on television or radio. Each company, production company or producer or director will have to sign up for an account to the centralized system and repository of products as described in the invention.

Within the production companies, networks, producers, or director's account or website, they will have a matching interactive synchronized chronological calendar of programs being aired, to that of the television or radio networks calendar of programs being aired. The purpose of this is so these producers, directors, or Production Company, or networks could match up the products being displayed on the particular show and sync it with the time and date the actual show, movie, or event will be shown or aired. Once again, all consumers will have a trigger to sync to the program to display the products they are viewing, inquiring, or want to purchase. Each product displayed comes with product detail information, a price, and where it can be purchased. Products can display by selecting the show anytime or during the time shown or trigger of the mobile digital device syncing with the television set or radio station.

In this invention, commercials, shows, movies, events, and news are equal to or the same as video, video data, video streaming when delivering or distributing advertising, content, products or services to the user, customer, or consumer.

While an exemplary embodiment of the invention has been described, it should be apparent that modifications and variations thereto are possible, all of which fall within the true spirit and scope of the invention. With respect to the above description then, it is to be realized that the optimum relationships for the components and steps of the invention, including variations in order, form, content, function and manner of operation, are deemed readily apparent and obvious to one skilled in the art, and all equivalent relationships to those illustrated in the drawings and described in the specification are intended to be encompassed by the present invention. The above description and drawings are illustrative of modifications that can be made without departing from the present invention, the scope of which is to be limited only by the following claims. Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents are intended to fall within the scope of the invention as claimed.

What is claimed is:

1. A computer-implemented matching system comprising
a base item identifier,
entries for a plurality of characterization specifications associated with the base item identifier,
a database containing a plurality of available item identifiers, and for each available item identifier including entries for a plurality of characterization specifications associated with the available item identifier,
a rules base comprising a plurality of predetermined matching rules, each matching rule determining if a base item identifier and an available item identifier are a match based upon the entries for the plurality of characterization specifications associated with the base item identifier and the entries for the plurality of characterization specifications associated with the available item identifier, and
a computing system on which is displayed information for an available item identifier that is determined to match the base item identifier.

2. The computer implemented matching system according to claim 1, the base item identifier being determined from a plurality of base item identifiers stored for a user.

3. The computer implemented matching system according to claim 1, the base item identifier being determined from a product identifier supplied by a user.

4. The computer implemented matching system according to claim 3, the product identifier being determined from an image of a code associated with a product.

5. The computer implemented matching system according to claim 1, the computing system containing a location module and the plurality of available item identifiers corresponding to items available at a location determined by the location module.

6. The computer implemented matching system according to claim 1, the displayed information for the available item identifier that is determined to match the base item identifier including a product image.

7. The computer implemented matching system according to claim 1, the displayed information for the available item identifier that is determined to match the base item identifier including a product identifier.

8. The computer implemented matching system according to claim 1, the displayed information for the available item identifier that is determined to match the base item identifier including a product price.

9. The computer implemented matching system according to claim 1, the displayed information for the available item identifier that is determined to match the base item identifier including a product location.

10. The computer implemented matching system according to claim 1, the displayed information for the available item identifier that is determined to match the base item identifier including a product stock availability indicator.

11. A computer-implemented matching method comprising
determining a base item identifier,
obtaining entries for a plurality of characterization specifications associated with the base item identifier,
accessing a database containing a plurality of available item identifiers, and for each available item identifier determining entries for a plurality of characterization specifications associated with the available item identifier,
applying a rule from a rules base, the rules base comprising a plurality of predetermined matching rules, each matching rule determining if a base item identifier and an available item identifier are a match based upon the entries for the plurality of characterization specifications associated with the base item identifier and the entries for the plurality of characterization specifications associated with the available item identifier, and
displaying on a computing system information for the available item identifier that is determined to match the base item identifier.

12. The computer implemented matching method according to claim 11, the base item identifier being determined from a plurality of base item identifiers stored for a user.

13. The computer implemented matching method according to claim 11, the base item identifier being determined from a product identifier supplied by a user.

14. The computer implemented matching method according to claim 13, the product identifier being determined from an image of a code associated with a product.

15. The computer implemented matching method according to claim 11, the computing system containing a location module and the plurality of available item identifiers corresponding to items available at a location determined by the location module.

16. The computer implemented matching method according to claim 11, the displayed information for the available item identifier that is determined to match the base item identifier including a product image.

17. The computer implemented matching method according to claim 11, the displayed information for the available item identifier that is determined to match the base item identifier including a product identifier.

18. The computer implemented matching method according to claim 11, the displayed information for the available item identifier that is determined to match the base item identifier including a product price.

19. The computer implemented matching method according to claim 11, the displayed information for the available item identifier that is determined to match the base item identifier including a product location.

20. The computer implemented matching method according to claim 11, the displayed information for the available item identifier that is determined to match the base item identifier including a product stock availability indicator.
